(19) United States
(12) Patent Application Publication
(10) Pub. No.: US 2026/0094365 A1
(43) Pub. Date: Apr. 2, 2026

(54) SYSTEMS AND METHODS FOR GENERATING A VIRTUAL REPRESENTATION OF AN ENVIRONMENT

(71) Applicant: Apple Inc., Cupertino, CA (US)

(72) Inventors: Zachary Z. BECKER, Issaquah, WA (US); Thorsten GERNOTH, San Francisco, CA (US); Lei ZHOU, San Jose, CA (US); Tian FANG, Guangzhou (CN)

(21) Appl. No.: 19/334,365

(22) Filed: Sep. 19, 2025

Related U.S. Application Data
(60) Provisional application No. 63/700,562, filed on Sep. 27, 2024.

(51) Int. Cl. G06T 17/00; G06F 3/04815

(52) U.S. Cl. CPC G06T 17/00; G06F 3/04815

(57) ABSTRACT

In some examples, an electronic device in communication with a display and one or more input devices performs a capture process for generating a virtual representation of an environment. In some examples, performing the capture process includes, during a first phase of the capture process, presenting, via the display, one or more first virtual elements in a representation of the environment for positioning the electronic device in a first manner while capturing images of the environment. In some examples, performing the capture process includes, during a second phase of the capture process, presenting, via the display, one or more second virtual elements in the representation of the environment for positioning the electronic device in a second manner while capturing images of the environment.

### CROSS REFERENCE TO RELATED APPLICATIONS

This application claims the benefit of U.S. Provisional Application No. 63/700,562, filed Sep. 27, 2024, the content of which is herein incorporated by reference in its entirety for all purposes.

### FIELD OF THE DISCLOSURE

This relates generally to user interfaces that enable a user to scan portions of a real-world environment using an electronic device.

### BACKGROUND OF THE DISCLOSURE

Extended reality environments are environments where at least some objects displayed for a user's viewing are generated using an electronic device. A user may create virtual representations that are based on physical objects to insert into extended reality environments.

### SUMMARY OF THE DISCLOSURE

Some examples of the disclosure are directed to systems and methods for performing a capture process for generating a virtual representation of one or more portions of an environment (e.g., a physical environment). In some examples, the capture process includes multiple phases. In some examples, each phase of the capture process includes positioning the electronic device in a different manner (e.g., holding the electronic device at a particular height, pose (e.g., orientation), and/or viewing angle), and maintaining the positioning (e.g., the height, pose, and/or viewing angle) of the electronic device while moving the electronic device (e.g., translationally) relative to the environment. For example, the electronic device captures images (e.g., automatically) of the environment while moving relative to the environment. For example, the captured images are used to generate a virtual representation (e.g., a three-dimensional model) of the environment.

In some examples, an electronic device in communication with a display and one or more input devices performs a capture process for generating a virtual representation of an environment. In some examples, performing the capture process includes, during a first phase of the capture process, presenting, via the display, one or more first virtual elements in a representation of the environment for positioning the electronic device in a first manner while capturing images of the environment. In some examples, performing the capture process includes, during a second phase of the capture process, presenting, via the display, one or more second virtual elements, different from the one or more first virtual elements, in the representation of the environment for positioning the electronic device in a second manner while capturing images of the environment.

The full descriptions of the examples are provided in the Drawings and the Detailed Description, and it is understood that this Summary does not limit the scope of the disclosure in any way.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 illustrates an example object scanning process in accordance with some examples of the disclosure.

FIG. 2 illustrates block diagrams of example architectures for devices according to some examples of the disclosure.

FIG. 3 illustrates an example capture process for generating a virtual representation of an environment according to some examples of the disclosure.

FIGS. 4A-4N illustrate examples of an electronic device presenting example user interfaces for a first capture process for generating a virtual representation of an environment according to some examples of the disclosure.

FIGS. 5A-5N illustrate examples of an electronic device presenting example user interfaces for a second capture process for generating a virtual representation of an environment according to some examples of the disclosure.

FIGS. 6A-6C illustrate examples of an electronic device presenting example user interfaces for a third capture process for generating a virtual representation of an environment according to some examples of the disclosure.

FIGS. 7A-7B illustrate examples of an electronic device presenting example user interface for a fourth capture process for generating a virtual representation of an environment according to some examples of the disclosure.

FIG. 8 illustrates a flow diagram of an example process for performing a capture process for generating a virtual representation of an environment according to some examples of the disclosure.

### DETAILED DESCRIPTION

Some examples of the disclosure are directed to systems and methods for performing a capture process for generating a virtual representation of one or more portions of an environment (e.g., a physical environment). In some examples, the capture process includes multiple phases. In some examples, each phase of the capture process includes positioning the electronic device in a different manner (e.g., holding the electronic device at a particular height, pose (e.g., orientation), and/or viewing angle), and maintaining the positioning (e.g., the height, pose, and/or viewing angle) of the electronic device while moving the electronic device (e.g., translationally) relative to the environment. For example, the electronic device captures images (e.g., automatically) of the environment while moving relative to the environment. For example, the captured images are used to generate a virtual representation (e.g., a three-dimensional model) of the environment.

In some examples, an electronic device in communication with a display and one or more input devices performs a capture process for generating a virtual representation of an environment. In some examples, performing the capture process includes, during a first phase of the capture process, presenting, via the display, one or more first virtual elements in a representation of the environment for positioning the electronic device in a first manner while capturing images of the environment. In some examples, performing the capture process includes, during a second phase of the capture process, presenting, via the display, one or more second virtual elements, different from the one or more first virtual elements, in the representation of the environment for positioning the electronic device in a second manner while capturing images of the environment.

In the following description of examples, reference is made to the accompanying drawings which form a part of this Specification, and in which it is shown by way of illustration, specific examples that are within the scope of the present disclosure. It is to be understood that other examples are also within the scope of the present disclosure and structural changes can be made without departing from the scope of the disclosure.

As used herein, the phrases “the,” “a,” and “an” include both the singular forms (e.g., one element) and plural forms (e.g., a plurality of elements), unless explicitly indicated or the context indicates otherwise. The term “and/or” encompasses any and all possible combinations of the listed items (e.g., including examples that include none of some of the listed items). The terms “comprises,” and/or “includes,” specify the inclusion of stated elements, but do not exclude the addition of other elements (e.g., the existence of other elements that are not explicitly recited in and of itself does not render an example from not “including” or “comprising” an explicitly recited element). As used herein, the terms “first,” “second,” etc. are used to describe various elements, but these terms should not be interpreted as limiting the various elements, and are used merely to distinguish one element from another (e.g., to distinguish two of the same type of element from each other). The term “if” can be interpreted to mean “when,” “upon” (e.g., optionally including a temporal element) or “in response to” (e.g., without requiring a temporal element).

Physical settings are those in the world where people can sense and/or interact without use of electronic systems (e.g., the real-world environment, the physical environment, etc.). For example, a room is a physical setting that includes physical elements, such as, physical chairs, physical desks, physical lamps, and so forth. A person can sense and interact with these physical elements of the physical setting through direct touch, taste, sight, smell, and hearing.

In contrast to a physical setting, an extended reality (XR) setting refers to a computer-produced environment that is partially or entirely generated using computer-produced content. While a person can interact with the XR setting using various electronic systems, this interaction utilizes various electronic sensors to monitor the person's actions, and translates those actions into corresponding actions in the XR setting. For example, if an XR system detects that a person is looking upward, the XR system may change its graphics and audio output to present XR content in a manner consistent with the upward movement. XR settings may incorporate laws of physics to mimic physical settings.

Concepts of XR include virtual reality (VR) and augmented reality (AR). Concepts of XR also include mixed reality (MR), which is sometimes used to refer to the spectrum of realities between physical settings (but not including physical settings) at one end and VR at the other end. Concepts of XR also include augmented virtuality (AV), in which a virtual or computer-produced setting integrates sensory inputs from a physical setting. These inputs may represent characteristics of a physical setting. For example, a virtual object may be displayed in a color captured, using an image sensor, from the physical setting. As another example, an AV setting may adopt current weather conditions of the physical setting.

Some electronic systems for implementing XR operate with an opaque display and one or more imaging sensors for capturing video and/or images of a physical setting. In some implementations, when a system captures images of a physical setting, and displays a representation of the physical setting on an opaque display using the captured images, the displayed images are called a video pass-through. Some electronic systems for implementing XR operate with an optical see-through display that may be transparent or semi-transparent (and optionally with one or more imaging sensors). Such a display allows a person to view a physical setting directly through the display, and allows for virtual content to be added to the person's field-of-view by superimposing the content over an optical pass-through of the physical setting (e.g., overlaid over portions of the physical setting, obscuring portions of the physical setting, etc.). Some electronic systems for implementing XR operate with a projection system that projects virtual objects onto a physical setting. The projector may present a holograph onto a physical setting, or may project imagery onto a physical surface, or may project onto the eyes (e.g., retina) of a person, for example.

Electronic systems providing XR settings can have various form factors. A smartphone or a tablet computer may incorporate imaging and display components to present an XR setting. A head-mountable system may include imaging and display components to present an XR setting. These systems may provide computing resources for generating XR settings, and may work in conjunction with one another to generate and/or present XR settings. For example, a smartphone or a tablet can connect with a head-mounted display to present XR settings. As another example, a computer may connect with home entertainment components or vehicular systems to provide an on-window display or a heads-up display. Electronic systems displaying XR settings may utilize display technologies such as light-emitting diodes (LEDs), organic LEDs (OLEDs), quantum dot LEDS (QD-LEDs), liquid crystal on silicon, a laser scanning light source, a digital light projector, or combinations thereof. Display technologies can employ substrates, through which light is transmitted, including light waveguides, holographic substrates, optical reflectors and combiners, or combinations thereof.

Examples of electronic devices, user interfaces for such devices, and associated processes for using such devices are described. In some examples, the device is a portable communications device, such as a mobile telephone, that also contains other functions, such as PDA and/or music player functions. Other portable electronic devices, such as laptops, tablet computers with touch-sensitive surfaces (e.g., touch screen displays and/or touch pads), or wearable devices, are, optionally, used. It should also be understood that, in some examples, the device is not a portable communications device, but is a desktop computer or a television with a touch-sensitive surface (e.g., a touch screen display and/or a touch pad). In some examples, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some examples, the device has a display, but is capable of receiving input information from a separate input device having one or more input mechanisms (such as one or more buttons, a touch screen display and/or a touch pad).

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

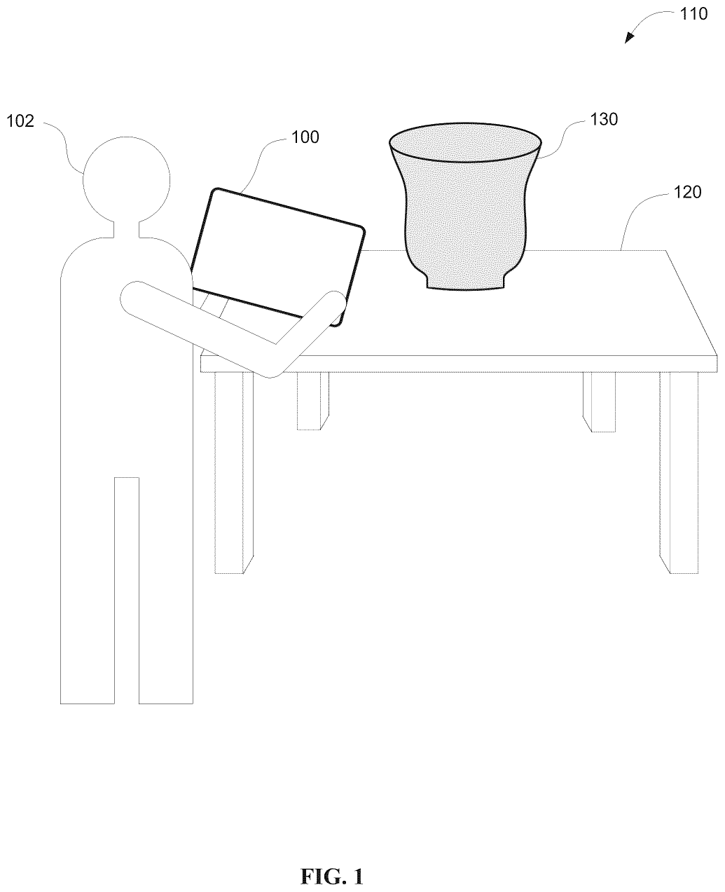

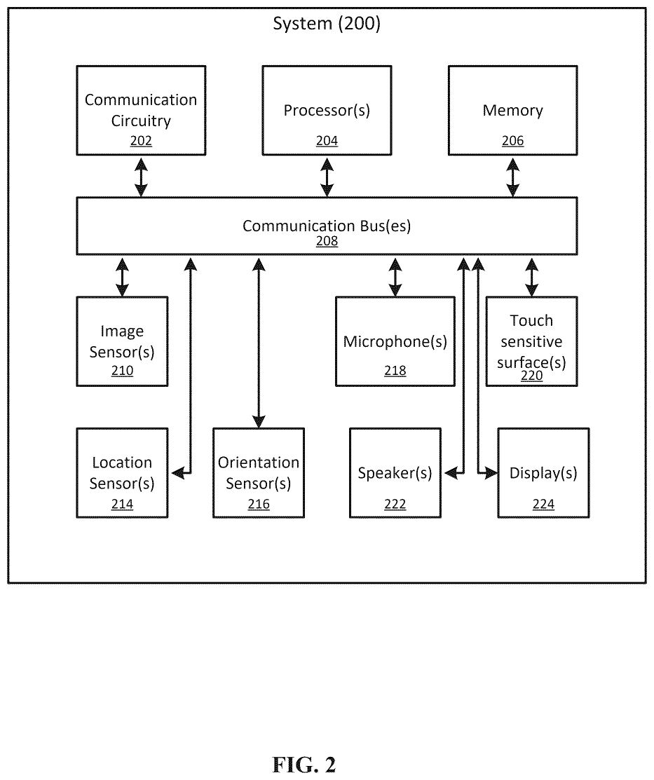

FIG. 1 illustrates user 102 and electronic device 100. In some examples, electronic device 100 is a hand-held or mobile device, such as a tablet computer or a smartphone. Examples of electronic device 100 are described below with reference to FIG. 2. As shown in FIG. 1, user 102 is located in the physical environment 110. In some examples, physical environment 110 includes table 120 and a physical object 130 positioned on top of table 120. In some examples, electronic device 100 may be configured to capture areas of physical environment 110. As will be discussed in more detail below, electronic device 100 includes one or more image sensor(s) that is configured to capture information about the objects in physical environment 110. In some examples, a user may desire to capture an object, such as physical object 130, and generate a virtual representation (e.g., a three-dimensional model) of physical object 130 (e.g., for use in an XR environment).

It should be appreciated that a user may desire to capture a plurality of objects (e.g., physical objects) of a physical (e.g., real-world) environment. For example, the user may desire to generate a virtual representation (e.g., three-dimensional model) of a region of a physical environment that includes a plurality of objects (e.g., to create a three-dimensional model of a scene and/or landscape). For example, a user may desire to generate a virtual representation of one or more physical objects of physical environment, such as trees, plants, rocks, etc. that are included in an outdoor location. The examples described herein describe systems and methods for capturing information about one or more portions of a physical (e.g., real-world) environment (e.g., and/or one or more physical objects of the physical environment) and generating a virtual representation of the one or more portions of the physical environment (e.g., to be used in an XR environment).

Attention is now directed toward examples of portable or non-portable devices with touch-sensitive displays, though the devices need not include touch-sensitive displays or displays in general, as described above. In some examples, the example devices are used to capture a set of images of one or more regions (e.g., and/or one or more physical objects) of an environment (e.g., a physical environment) to generate a virtual representation (e.g., a three-dimensional model). For example, a display of the device presents a user interface for one or more capture processes. The electronic device presents visual guidance to a user during the one or more capture processes, thereby reducing errors in capturing the set of images and/or generating the virtual representation.

FIG. 2 illustrates a block diagrams of example architectures for electronic device 200 in accordance with some examples. In some examples, electronic device 200 is a mobile device, such as a mobile phone (e.g., smart phone), a tablet computer, a laptop computer, an auxiliary device in communication with another device, etc. In some examples, as illustrated in FIG. 2, electronic device 200 includes various components, such as communication circuitry (202), processor(s) 204, memory (206), image sensor(s) 210, location sensor(s) 214, orientation sensor(s) 216, microphone(s) 218, touch-sensitive surface(s) (220), speaker(s) 222, and/or display(s) 224. These components optionally communicate over communication bus(es) 208 of electronic device 200.

Electronic device 200 includes communication circuitry 202. Communication circuitry 202 optionally includes circuitry for communicating with electronic devices, networks, such as the Internet, intranets, a wired network and/or a wireless network, cellular networks and wireless local area networks (LANs). Communication circuitry 202 optionally includes circuitry for communicating using near-field communication and/or short-range communication, such as Bluetooth®.

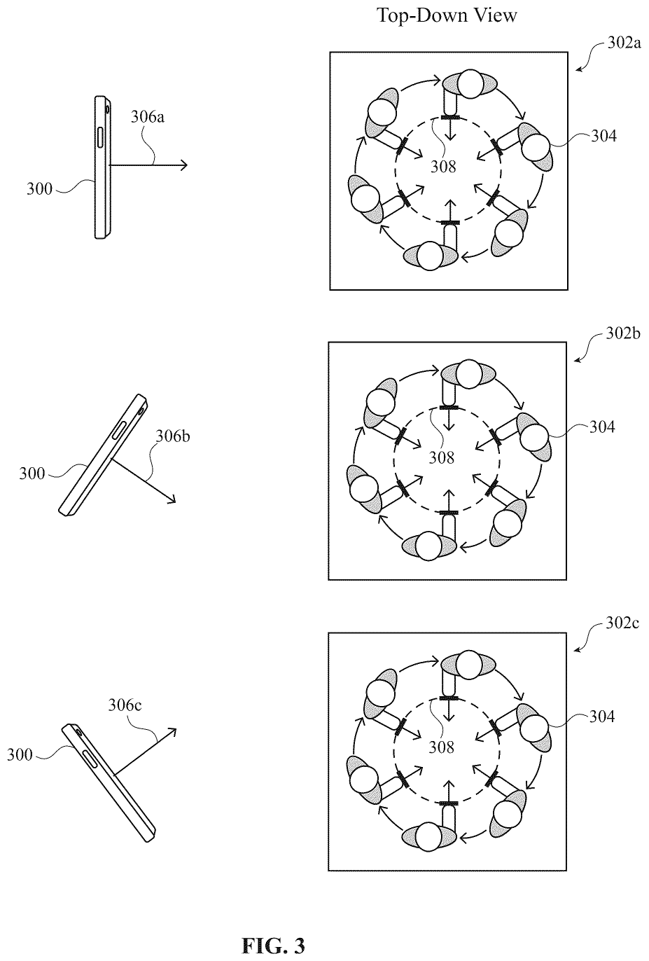

Processor(s) 204 include one or more general processors, one or more graphics processors, and/or one or more digital signal processors. In some examples, memory 206 are one or more non-transitory computer-readable storage mediums (e.g., flash memory, random access memory) that store computer-readable instructions configured to be executed by processor(s) 204 to perform the techniques, processes, and/or methods described below (e.g., with reference to FIGS. 3-7). A non-transitory computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital video disc (DVD), or Blu-ray technologies, as well as persistent solid-state memory such as flash, solid-state drives, and the like.

Electronic device 200 includes display(s) 224. In some examples, display(s) 224 include a single display. In some examples, display(s) 224 includes multiple displays. In some examples, electronic device 200 includes touch-sensitive surface(s) 220 for receiving user inputs, such as tap inputs and swipe inputs. In some examples, display(s) 224 and touch-sensitive surface(s) 220 form touch-sensitive display(s) (e.g., a touch screen integrated with electronic device 200 or external to electronic device 200 that is in communication with electronic device 200).

Electronic device 200 includes image sensor(s) 210 (e.g., capture devices). Image sensors(s) 210 optionally include one or more visible light image sensor, such as charged coupled device (CCD) sensors, and/or complementary metal-oxide-semiconductor (CMOS) sensors operable to obtain images of physical objects from the real environment. Image sensor(s) 210 also optionally include one or more infrared (IR) sensor(s), such as a passive IR sensor or an active IR sensor, for detecting infrared light from the real environment. For example, an active IR sensor includes an IR emitter, such as an IR dot emitter, for emitting infrared light into the real environment. Image sensor(s) 210 also optionally include one or more event camera(s) configured to capture movement of physical objects in the real environment. Image sensor(s) 210 also optionally include one or more depth sensor(s) configured to detect the distance of physical objects from electronic device 200. In some examples, information from one or more depth sensor(s) can allow the device to identify and differentiate objects in the real environment from other objects in the real environment. In some examples, one or more depth sensor(s) can allow the device to determine the texture and/or topography of objects in the real environment.

In some examples, electronic device 200 uses CCD sensors, event cameras, and depth sensors in combination to detect the physical environment around electronic device 200. In some examples, image sensor(s) 210 include a first image sensor and a second image sensor. The first image sensor and the second image sensor work in tandem and are optionally configured to capture different information of physical objects in the real environment. In some examples, the first image sensor is a visible light image sensor and the second image sensor is a depth sensor. In some examples, electronic device 200 uses image sensor(s) 210 to detect the position and orientation of electronic device 200 and/or display(s) 224 in the real environment. For example, electronic device 200 uses image sensor(s) 210 to track the position and orientation of display(s) 224 relative to one or more fixed objects in the real environment.

In some examples, electronic device 200 includes microphones(s) 218. Electronic device 200 uses microphone(s) 218 to detect sound from the user and/or the real environment of the user. In some examples, microphone(s) 218 includes an array of microphones (including a plurality of microphones) that optionally operate in tandem, such as to identify ambient noise or to locate the source of sound in space of the real environment.

Electronic device 200 includes location sensor(s) 214 for detecting a location of electronic device 200 and/or display(s) 224. For example, location sensor(s) 214 can include a global positioning system (GPS) receiver that receives data from one or more satellites and allows electronic device 200 to determine the device's absolute position in the world.

Electronic device 200 includes orientation sensor(s) 216 for detecting orientation and/or movement of electronic device 200 and/or display(s) 224. For example, electronic device 200 uses orientation sensor(s) 216 to track changes in the position and/or orientation of electronic device 200 and/or display(s) 224, such as with respect to physical objects in the real environment. Orientation sensor(s) 216 optionally include one or more gyroscopes and/or one or more accelerometers.

Electronic device 200 is not limited to the components and configuration of FIG. 2, but can include other or additional components in multiple configurations.

Attention is now directed towards example methods and processes, and associated user interfaces (“UI”), that are implemented using an electronic device, such as electronic device 100 or electronic device 200. The examples described below provide ways in which an electronic device captures images of an environment (e.g., a physical environment) that may be used to generate a virtual representation (e.g., a three-dimensional model to be used in an XR environment) of the environment.

In some examples, methods for generating a virtual representation of an environment (e.g., a physical environment), such as through gaussian splatting techniques, require images to be captured of a one or more regions of the environment from different vantage points. To perform such capturing, and to create accurate virtual representations, a user of the electronic device may be required to position the electronic device in different manners (e.g., at different poses (e.g., orientations), heights, and/or viewing angles).

FIG. 3 illustrates an example capture process for generating a virtual representation of an environment (e.g., a physical environment), according to some examples of the disclosure. In some examples, the capture process is performed by a user 304 using an electronic device 300, which optionally has one or more characteristics of electronic device 100 and/or 200 shown and described with reference to FIGS. 1-2.

In some examples, the capture process illustrated in FIG. 3 has multiple phases. For example, at each phase of the capture process, images are captured while electronic device 300 is positioned (e.g., by user 304) in different manners (e.g., at different poses, heights, and/or viewing angles). For example, during a first phase of the capture process, electronic device 300 is positioned in a first manner 306a (represented by a schematic arrow extending from electronic device 300). For example, first manner 306a represents a first pose, height, and/or viewing angle of electronic device 300 relative to the environment. In some examples, by positioning electronic device 300 in the first manner 306a, user 304 aligns electronic device 300 (e.g., and/or one or more image sensors of electronic device 300, such as image sensor(s) 210 described above) toward a first region of the environment. For example, aligning electronic device 300 toward the first region of the environment during the first phase of the capture process includes capturing images of the environment while electronic device 300 (e.g., and/or the one or more image sensors of electronic device 300) is aligned toward a horizon of the environment.

In some examples, as shown in top-down view 302a, the first phase of the capture process includes moving electronic device 300 along a path 308. In some examples, path 308 corresponds to a range of locations and/or viewpoints in the environment that images may be captured from during the different phases of the capture process (e.g., electronic device 300 captures images automatically while user 304 moves electronic device 300 during the capture process). For example, images are optionally not captured from the same exact locations in the environment during each phase of the capture process (e.g., a user is only required to remain within a threshold range of locations (e.g., and/or distances relative to a target region of the environment) while moving during each phase of the capture process). Although path 308 is shown as a circular path in top-down views 302a to 302c (e.g., that surrounds a region of the environment), in some examples, path 308 is a different type of path (e.g., a straight path, a curved path, or a partially circular path (e.g., such that path 308 at least partially surrounds a target region of the environment). In some examples, during the first phase of the capture process, user 304 maintains positioning of electronic device 300 in the first manner 306a (e.g., and/or holds electronic device 300 within a threshold range of orientations from a first orientation associated with positioning electronic device 300 in first manner 306 (e.g., within 1, 2, 5, 10, 15, 20, 25, or 30 degrees of the first orientation)) while moving along path 308 (e.g., and/or within a range of locations) in the environment.

FIG. 3 further illustrates a second phase of the capture process. During a second phase of the capture process, optionally after the first phase of the capture process, electronic device 300 is positioned in a second manner 306b. For example, the second manner 306b represents a second pose (e.g., orientation), height, and/or viewing angle relative to the environment (e.g., different from the first pose, height, and/or viewing angle associated with positioning electronic device 300 in the first manner 306a). In some examples, by positioning electronic device 300 in the second manner 306b, user 304 aligns electronic device 300 (e.g., and/or the one or more image sensors of electronic device 300) toward a second region, different from the first region, of the environment. For example, aligning electronic device 300 toward the second region of the environment during the second phase of the capture process includes capturing images of the environment while electronic device 300 (e.g., and/or the one or more image sensors of electronic device 300) are aligned away (e.g., below) a horizon of the environment (e.g., electronic device 300 is held at an angle of depression relative to the environment while images are captured during the second phase of the capture process).

In some examples, as shown in top-down view 302b, the second phase of the capture process includes moving electronic device 300 along path 308. For example, during the second phase of the capture process, user 304 moves electronic device 300 along path 308 in the environment while positioning electronic device 300 in the second manner 306b (e.g., and/or within a threshold range of orientations from a second orientation associated with positioning electronic device 300 in the second manner 306b) instead of in the first manner 306a (e.g., such that images of the environment are captured from a different height, pose, and/or viewing angle relative to the environment during the second phase of the capture process than during the first phase of the capture process).

FIG. 3 further illustrates a third phase of the capture process. During a third phase of the capture process, optionally after the first phase and/or second phase of the capture process, electronic device 300 is positioned in a third manner 306c. For example, the third manner 306c represents a third pose (e.g., orientation), height, and/or viewing angle relative to the environment. In some examples, by positioning electronic device 300 in the third manner 306c, user 304 aligns electronic device 300 (e.g., and/or the one or more image sensors of electronic device 300) toward a third region, different from the first region and the second region, of the environment. For example, aligning electronic device 300 toward the third region of the environment during the third phase of the capture process includes capturing images of the environment while electronic device 300 (e.g., and/or the one or more image sensors of electronic device 300) are aligned away (e.g., above) a horizon of the environment (e.g., electronic device 300 is held at an angle of elevation relative to the environment while images are captured during the third phase of the capture process).

In some examples, as shown in top-down view 302c, the third phase of the capture process includes moving electronic device 300 along path 308. For example, during the third phase of the capture process, user 304 moves electronic device 300 along path 308 in the environment while positioning electronic device 300 in the third manner 306c (e.g., and/or within a threshold range of orientations from a third orientation associated with positioning electronic device 300 in the third manner 306c) instead of in the first manner 306a or the second manner 306b (e.g., such that images of the environment are captured from a different pose, height, and/or viewing angle relative to the environment during the third phase of the capture process than during the first phase or the second phase of the capture process).

It should be understood that the capture process shown and described with reference to FIG. 3 is an example and more, fewer, or different phases can be performed in the same or in a different order than described. For example, the capture process may include a fourth phase (e.g., after the first phase, second phase, and third phase). For example, during the fourth phase of the capture process, user 304 moves electronic device 300 along path 308 while aligning electronic device 300 (e.g., and/or one or more image sensors of electronic device 300) in an opposite direction than shown in top-down views 302a to 302c (e.g., as shown in top-down views 302a to 302c, path 308 surrounds a region of the environment, and the fourth phase of the capture process includes directing electronic device 300 away from (e.g., instead of toward) the region of the environment surrounded by path 308).

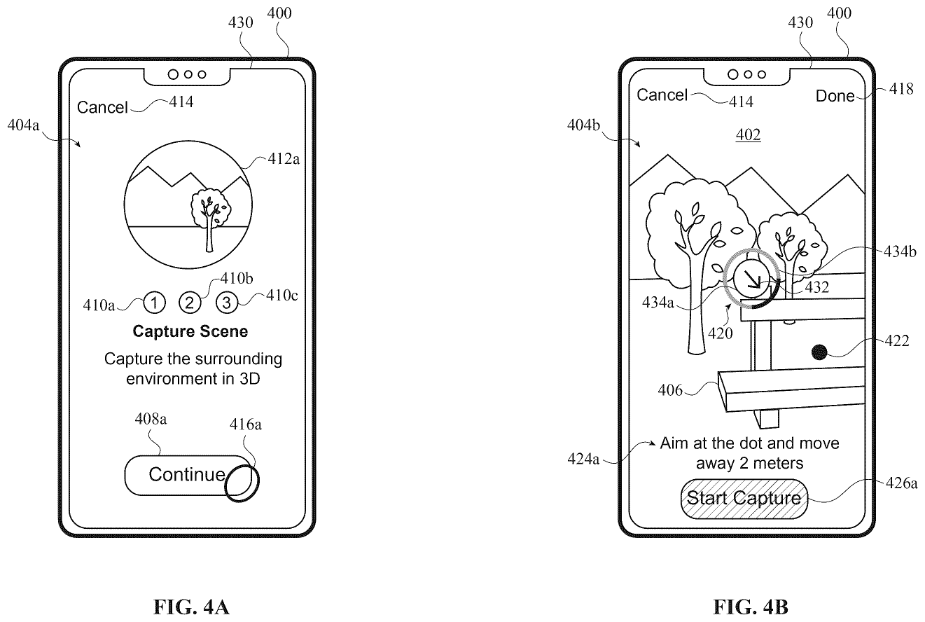

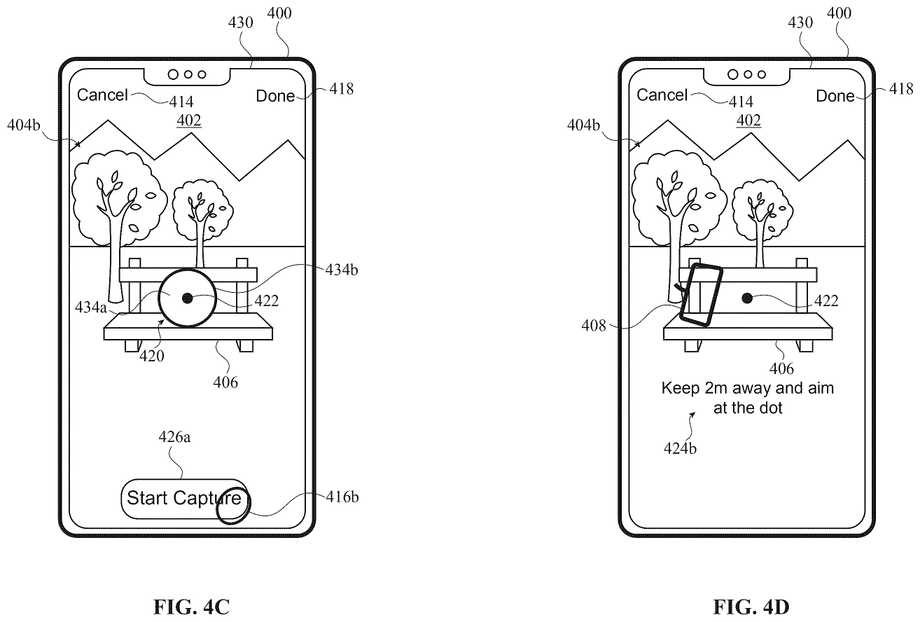

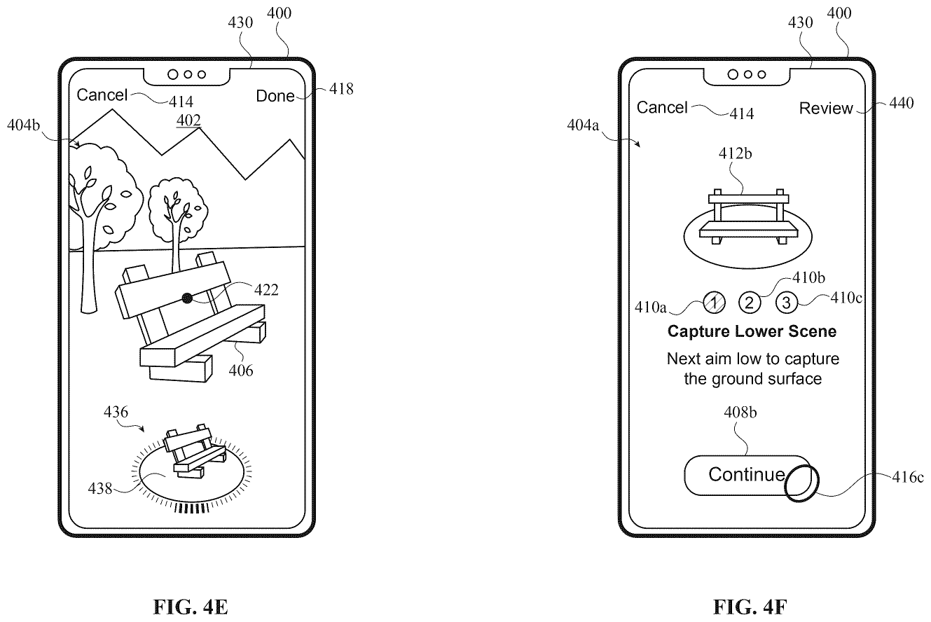

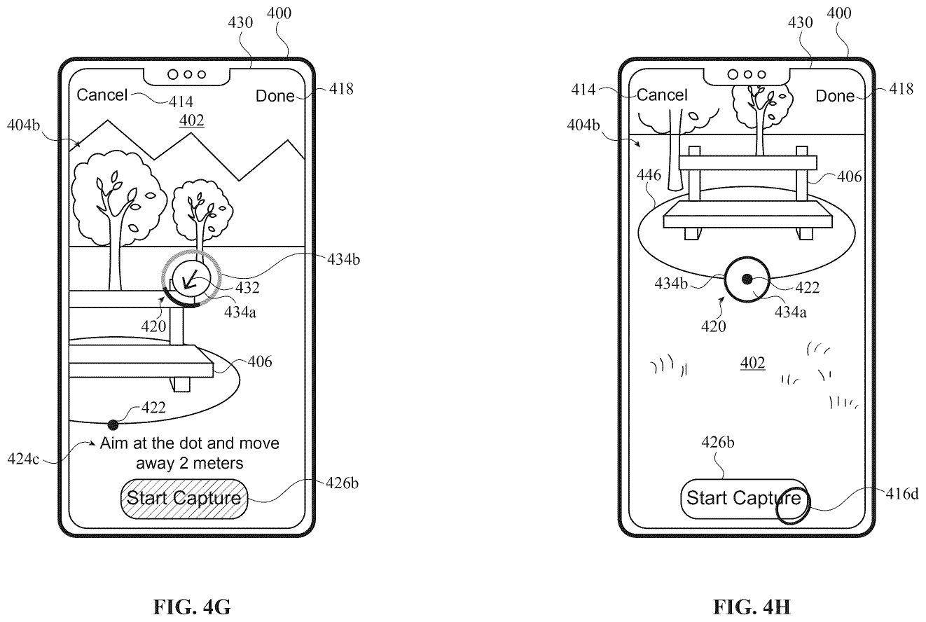

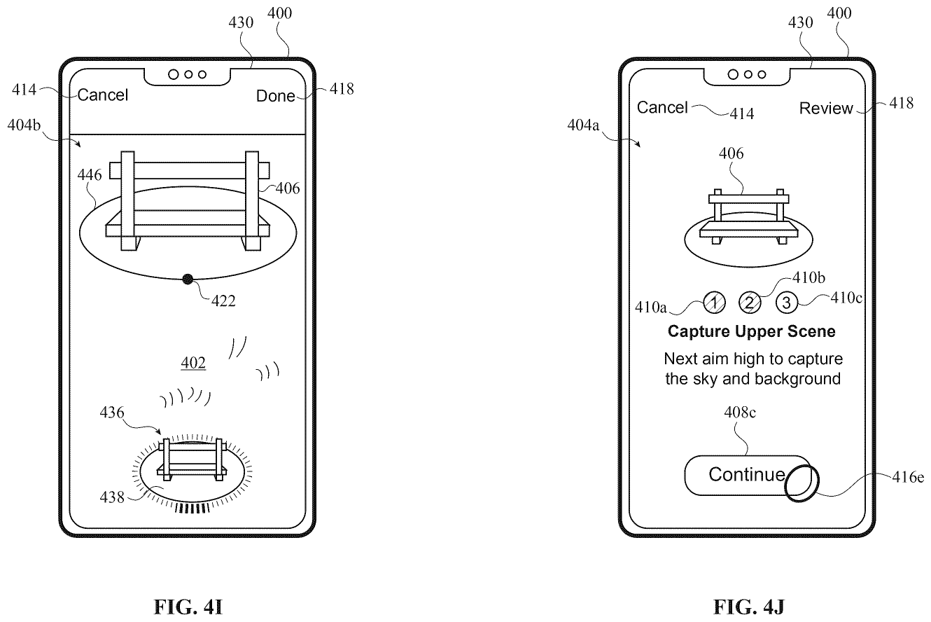

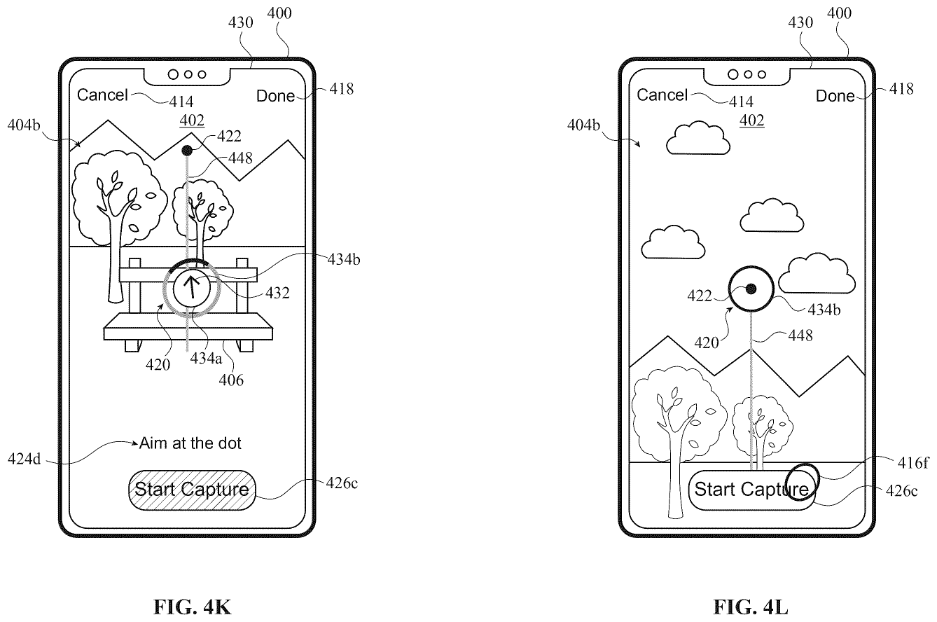

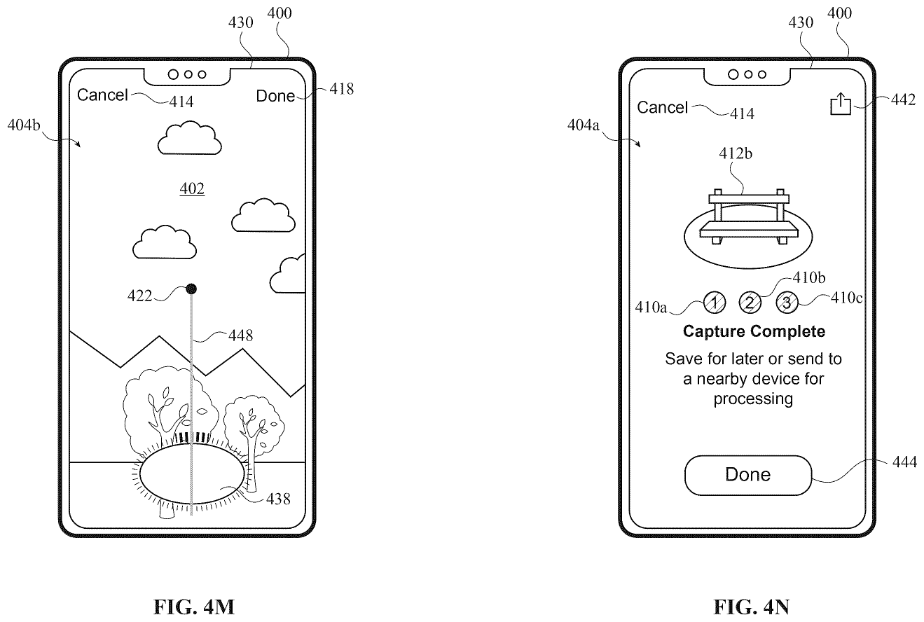

In some examples, an electronic device, such as electronic device 300, presents one or more virtual elements in a representation of an environment (e.g., a three-dimensional environment that includes a representation of a physical environment) to guide a user in positioning the electronic device during different phases of a capture process (e.g., the capture process shown and described with reference to FIG. 3). In some examples, the user interfaces described herein are associated with an application that is accessible via the electronic device (e.g., the application is associated with generating virtual representations of physical objects and/or environments). The example user interfaces described herein (and shown in FIGS. 4A-7B) improve user device interaction during the capture process by presenting (via a display of the electronic device) virtual elements (e.g., virtual objects) in a three-dimensional environment (e.g., including a representation of a physical environment) to guide the user in positioning the electronic device in the manners required for generating accurate virtual representations. The examples described herein limit errors in the capture process and conserve computing resources associated with correcting errors (e.g., by preventing the need to recapture images and/or regenerate virtual representations of one or more portions of an environment due to improper positioning of the electronic device).

As described below, an electronic device can include various user interfaces to facilitate the capturing of a set of images that are used to generate a virtual representation of one or more portions of an environment (e.g., a physical environment). Although the examples of FIGS. 4A-7B include user interfaces shown on a display of a hand-held device such as a cell phone, the user interfaces described herein are optionally implemented on a different type of electronic device, such as a head-mounted device (e.g., a headset used for presenting XR environments to a user), a smart watch, a tablet, a laptop, or another type of electronic device.

FIGS. 4A-4N illustrate examples of an electronic device presenting example user interfaces for a first capture process for generating a virtual representation of an environment, according to some examples of the disclosure. In some examples, the first capture process has one or more characteristics of the capture process shown and described with reference to FIG. 3.

FIG. 4A illustrates a user interface 404a for a first capture process for generating a virtual representation of an environment (e.g., a physical environment). User interface 404a is optionally presented (e.g., displayed) on a display 430 of an electronic device 400, which optionally has one or more characteristics of electronic device 100 and/or electronic device 200 shown and described with reference to FIGS. 1-2. In some examples, display 430 has one or more characteristics of display(s) 224 shown and described with reference to FIG. 2. In some examples, display 430 is a touch-sensitive display (e.g., configured to detect touch inputs).

User interface 404a is optionally an introductory and/or intermediate user interface for the first capture process (e.g., electronic device 400 presents user interface 404a in response to launching an application associated with the first capture process and/or in response to selection of a selectable option to initiate the first capture process). For example, electronic device 400 presents user interface 404a when initiating the first capture process and/or in between different phases of the first capture process. As shown in FIG. 4A, user interface 404a includes indications 410a to 410c. In some examples, indications 410a to 410c correspond to visual indications of different phases of the first capture process (e.g., indication 410a corresponds to a first phase, indication 410b corresponds to a second phase, and indication 410c corresponds to a third phase). For example, the first capture process includes three phases (e.g., a first phase, a second phase, and a third phase). Alternatively, the first capture process includes a different number of phases (e.g., more or fewer than three phases, such as two or four phases). In some examples, after a phase of the capture process is completed, electronic device 400 changes a visual appearance of the indication corresponding to the completed phase (e.g., after completing a first phase of the capture process, electronic device 400 presents indication 410a with a different shading and/or color to visually indicate that the first phase of the capture process is complete, as shown in FIG. 4F).

As shown in FIG. 4A, user interface 404a includes a representation 412a of an environment (e.g., a physical environment). Representation 412a optionally corresponds to a preview of one or more previously captured images of an environment (e.g., during a phase of the capture process that was optionally completed prior to FIG. 4A, images of an environment were captured by electronic device 400). Alternatively, in some examples, representation 412a corresponds to a logo and/or icon associated with the first capture process. Alternatively, in some examples, electronic device 400 presents user interface 404a without representation 412a (e.g., user interface 404a is presented when initiating the first capture process and/or one or more images of an environment have not yet been captured (e.g., an initial phase of the first capture process has not yet been initiated)).

As shown in FIG. 4A, user interface 404a includes selectable options. For example, in FIG. 4A, user interface 404a includes a selectable option 414. For example, selectable option 414 is selectable (e.g., through a touch input on display 430) to exit and/or cancel the first capture process. Further, as shown in FIG. 4A, user interface 404a includes a selectable option 408a. In some examples, selectable option 408a is selectable to initiate a first phase (e.g., or the next phase) of the first capture process. As shown in FIG. 4A, electronic device 400 detects a touch input 416a (represented by an oval in FIG. 4A) (e.g., a tap input) corresponding to selection of selectable option 408a. In response to detecting the selection of selectable option 408a, electronic device 400 initiates the first phase of the first capture process in FIG. 4B.

In some examples, FIGS. 4B-4E illustrate a first phase of the first capture process, which optionally has one or more characteristics of the first phase of the capture process described with reference to FIG. 3.

FIG. 4B illustrates electronic device 400 presenting, via display 430, a user interface 404b of the first capture process in response to detecting the selection of selectable option 408a in FIG. 4A. As shown in FIG. 4B, user interface 404b includes a view of an environment 402. In some examples, environment 402 includes a representation of a physical environment of a user of electronic device 400 (e.g., user 102 shown and described with reference to FIG. 1). For example, the view of environment 402 shown in FIG. 4B corresponds to a region of a physical environment of a user that is in the field-of-view of electronic device 400 (e.g., and/or of one or more input devices of electronic device 400, such as image sensor(s) 210). For example, the representation of the physical environment corresponds to a live view of the physical environment of the user that is generated using one or more image sensors of electronic device 400. In some examples, the representation of the physical environment included in environment 402 corresponds to the physical environment captured during the first capture process (e.g., at the conclusion of the first capture process, a virtual representation of the physical environment is generated using the images captured during the first capture process). In some examples, environment 402 included in user interface 404b is an extended reality (XR) environment having one or more characteristics of an XR environment described above. For example, one or more virtual elements (e.g., computer-generated objects, such as orientation guidance user interface object 420) and/or physical objects (e.g., real-world bench 406) of the physical environment are included in the presented view of environment 402 (e.g., the one or more virtual elements are presented in environment 402 within and/or overlaid on the representation of the physical environment).

In some examples, FIG. 4B illustrates a first portion of the first phase of the first capture process. In some examples, during the first portion of the first phase of the first capture process, electronic device 400 presents one or more virtual elements (e.g., virtual objects) in environment 402 for aligning electronic device 400 (e.g., and/or one or more image sensors of electronic device 400) relative to a first capture region of the physical environment (e.g., a region of the physical environment within the field-of-view of electronic device 400 when electronic device 400 is positioned by the user in the first manner). For example, as shown in FIG. 4B, electronic device 400 presents an orientation guidance user interface object 420. In some examples, orientation guidance user interface object 420 visually indicates to the user (e.g., using arrow 432) a target direction for positioning electronic device 400 in the first manner for capturing the first capture region of the physical environment. In some examples, as shown in FIG. 4B, electronic device 400 presents a target 422 in environment 402. For example, the target direction indicated by orientation guidance user interface object 420 corresponds to target 422 (e.g., orientation guidance user interface object 420 guides the user to change an orientation of electronic device 400 such that electronic device 400 (e.g., and/or the one or more image sensors of electronic device 400) is aligned with target 422).

In some examples, orientation guidance user interface object 420 visually indicates the amount of additional movement needed until electronic device 400 is positioned in the first manner (e.g., the amount of additional movement needed until orientation guidance user interface object 420 is aligned with target 422). For example, orientation guidance user interface object 420 includes an inner portion 434a (e.g., an inner circle) that changes in size based on the progress of movement of electronic device 400 toward being positioned in the first manner (e.g., as electronic device 400 is positioned closer to a first orientation associated with positioning electronic device 400 in the first manner, electronic device 400 increases the size of inner portion 434a). Further, for example, orientation guidance user interface object 420 includes an outer portion 434b that includes a progress bar (e.g., a circular progress bar) that is visually modified (e.g., shaded-in) based on the progress of movement of electronic device 400 toward being positioned in the first manner (e.g., as electronic device 400 is positioned closer to the first orientation associated with positioning electronic device 400 in the first manner, electronic device 400 increases the visually modified portion of the progress bar of outer portion 434b).

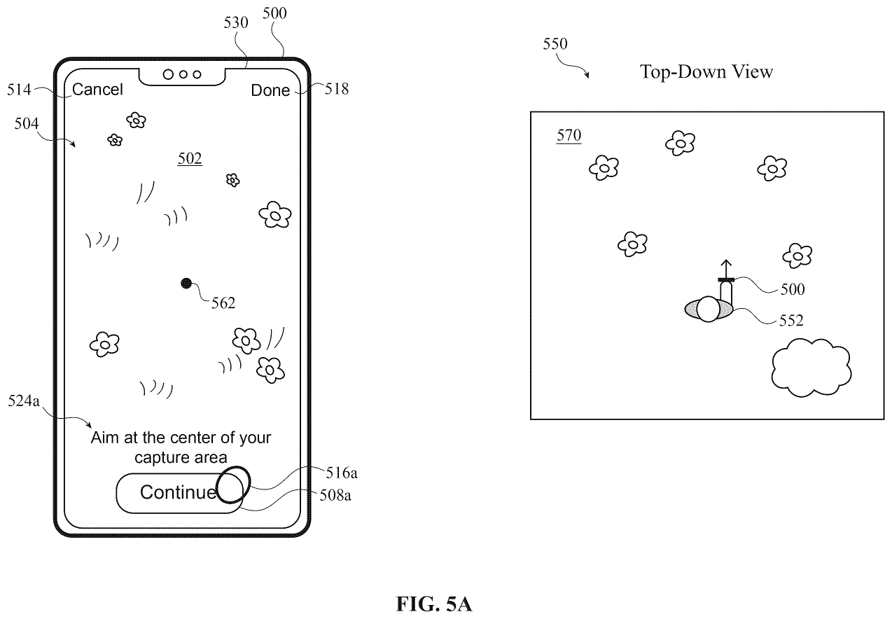

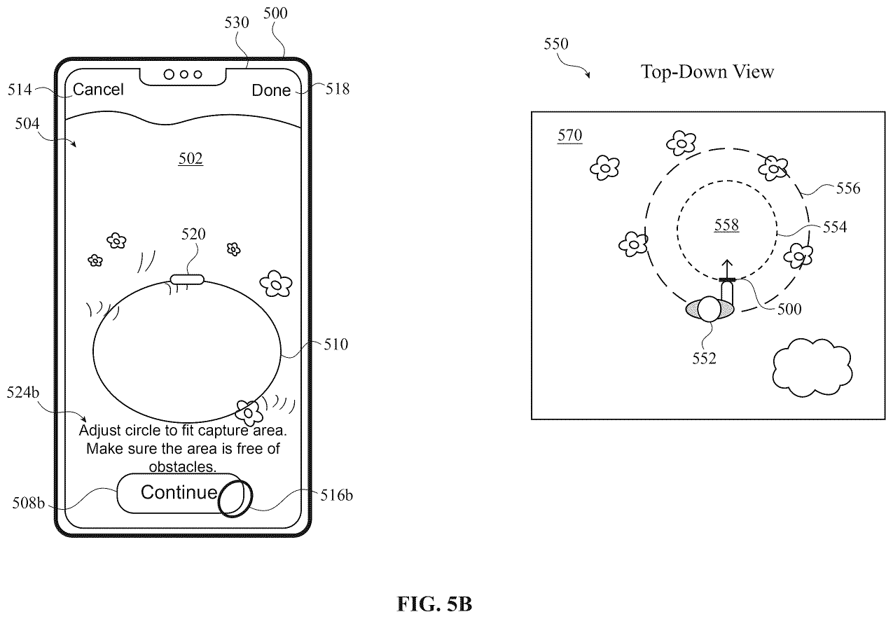

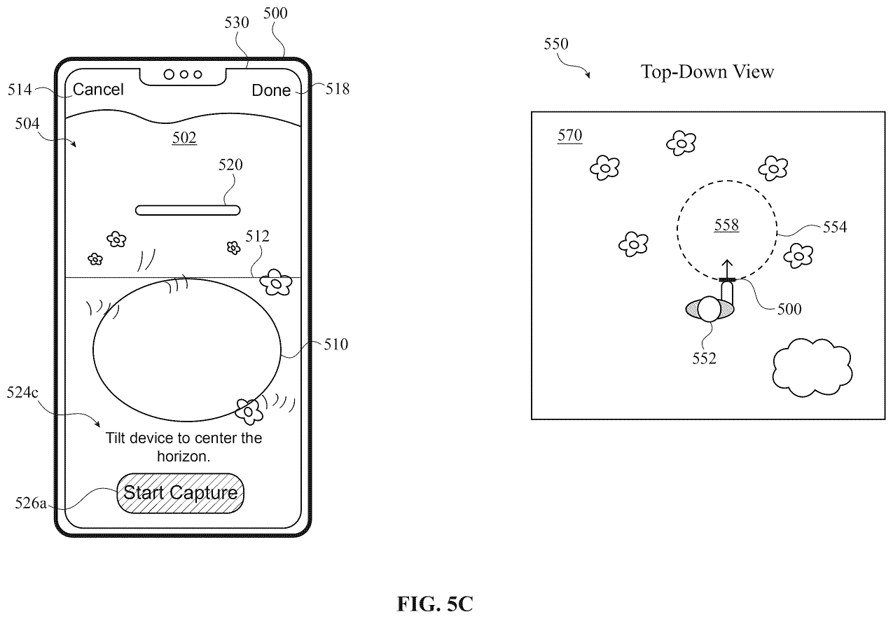

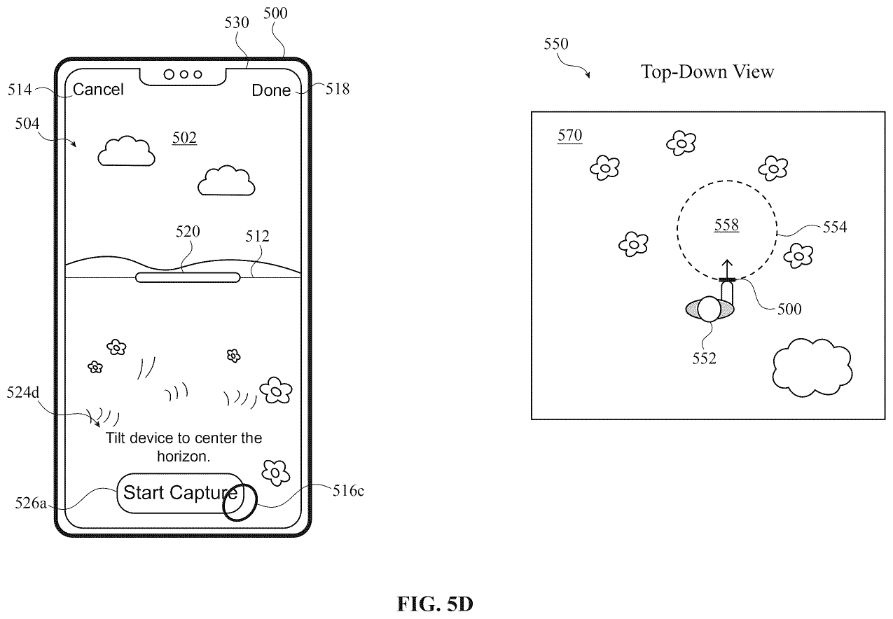

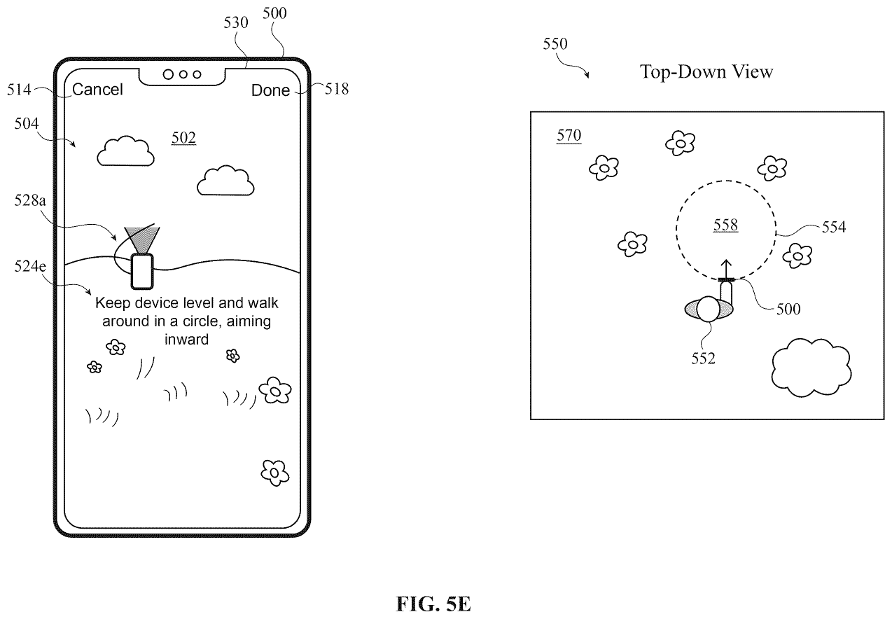

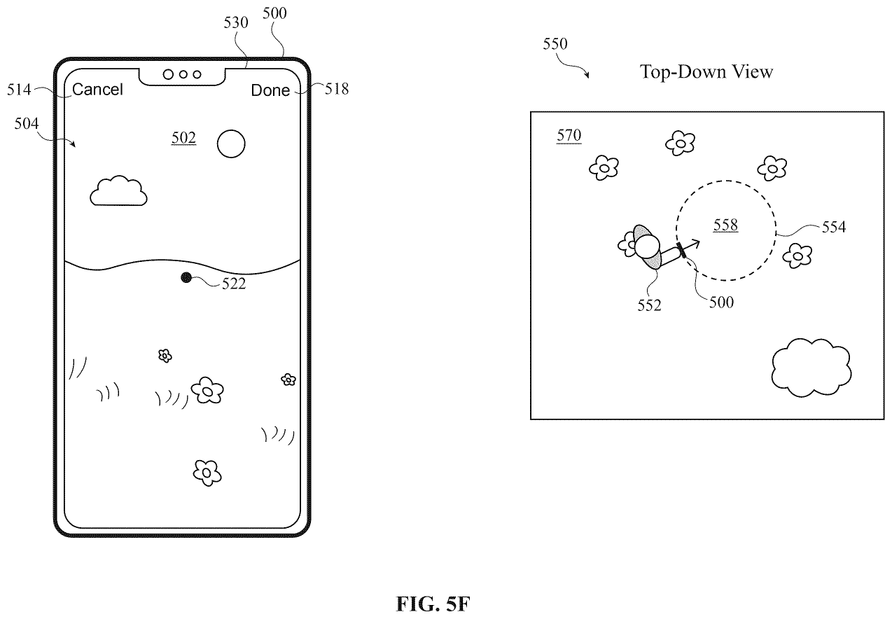

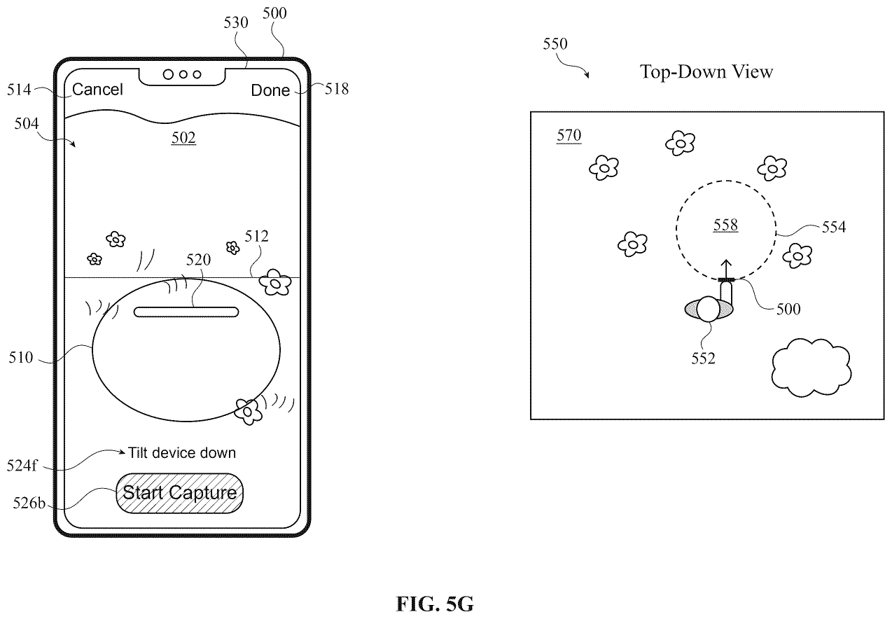

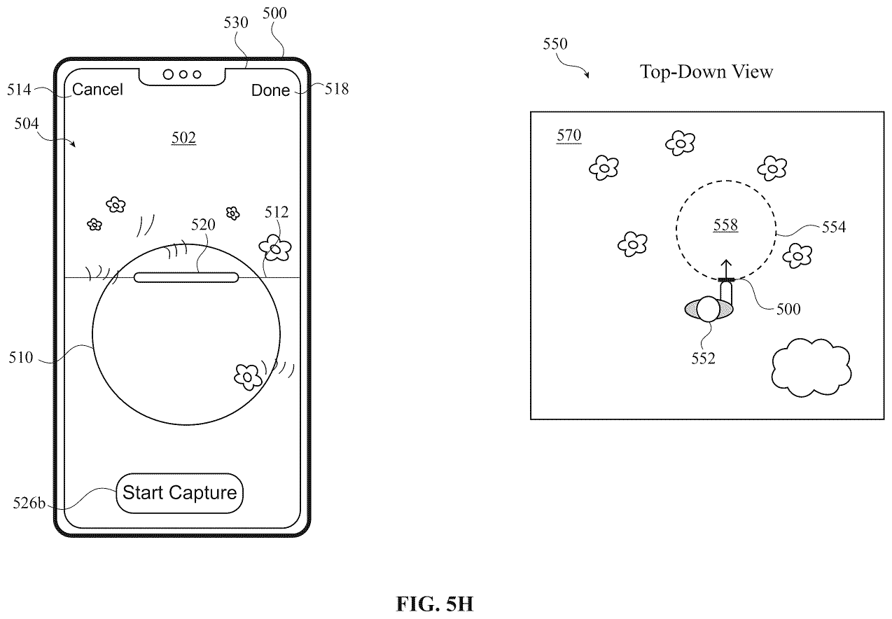

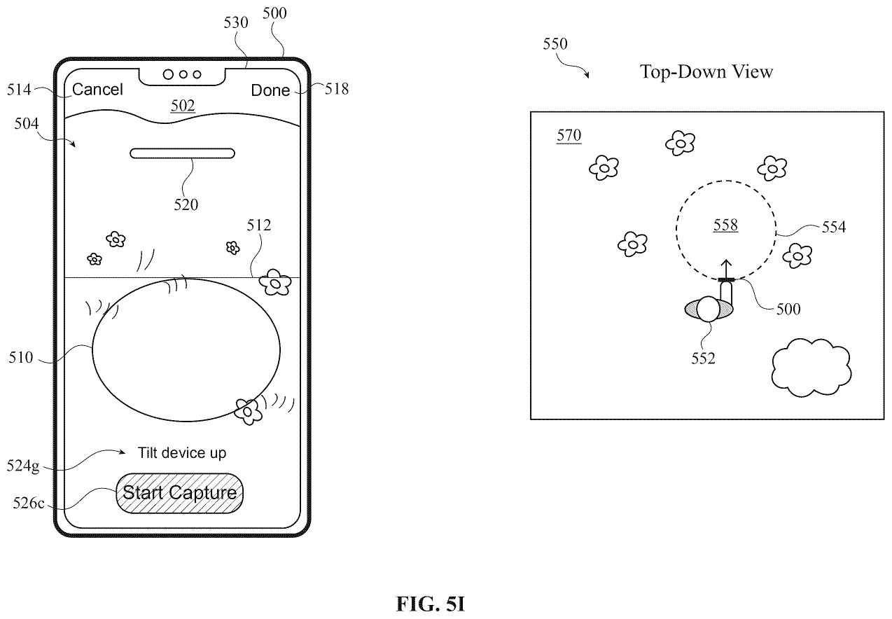

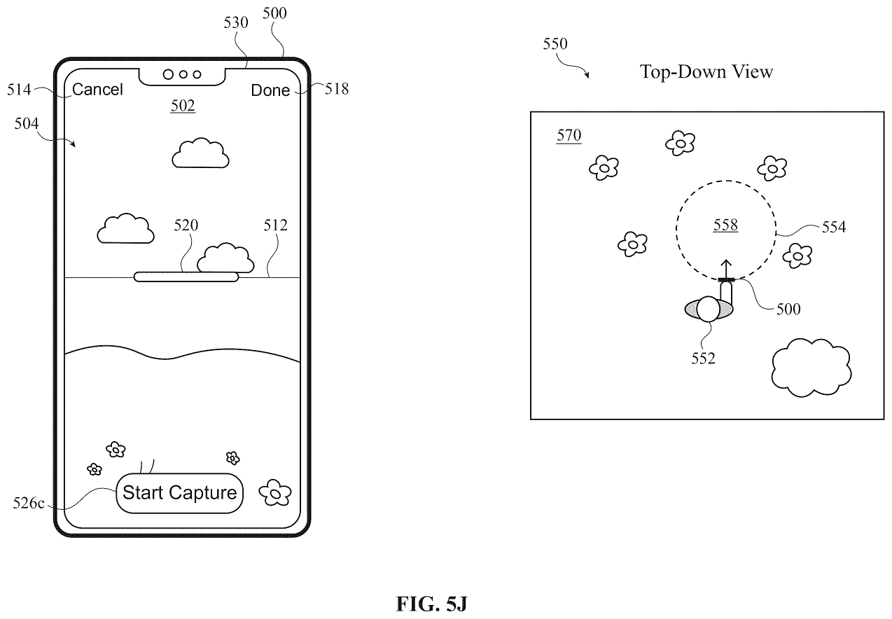

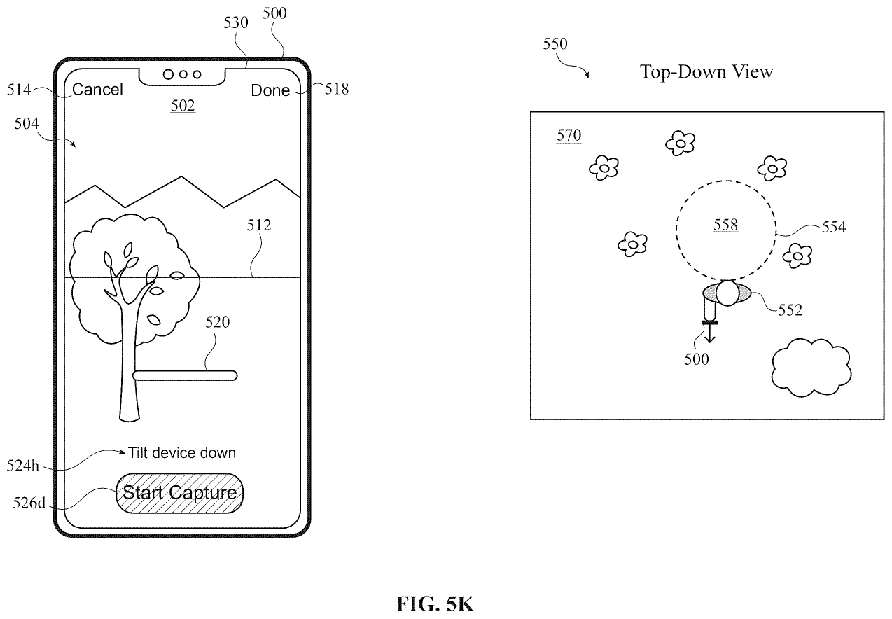

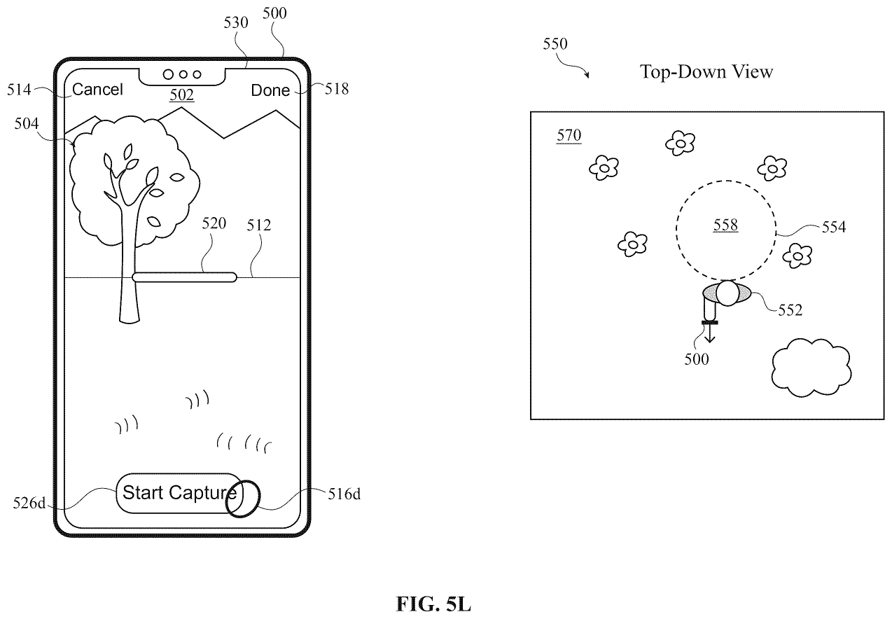

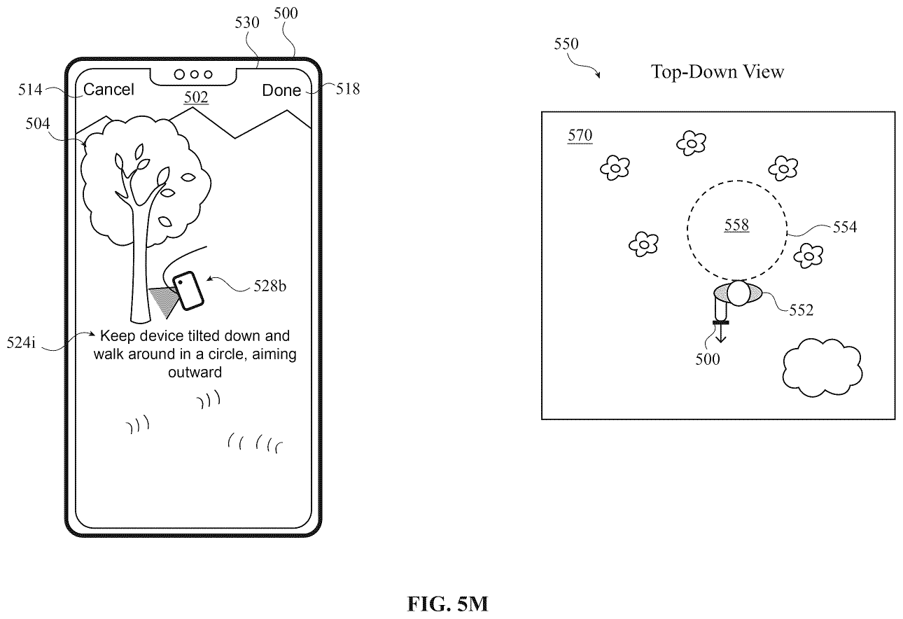

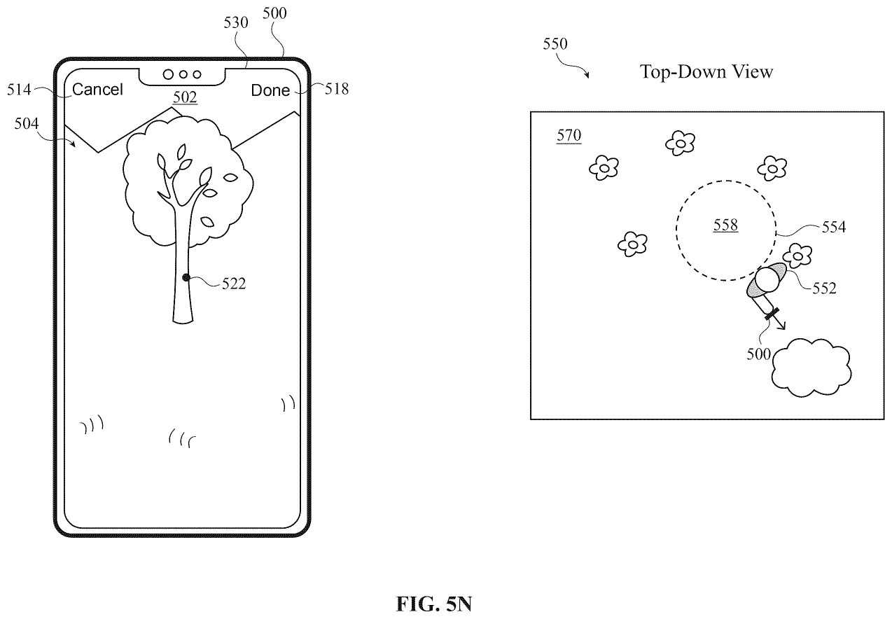

In some examples, orientation guidance user interface object 420 shown in FIG. 4B is an example orientation guidance user interface object, and alternative orientation guidance user interface objects may be included in user interface 404b (e.g., presented in environment 402) during the first portion of the first phase of the first capture process to visually guide the user in positioning electronic device 400 in the first manner. For example, electronic device 400 presents an orientation guidance user interface object having one or more characteristics of orientation guidance user interface object 520 shown and described with reference to FIG. 5C (e.g., and/or presents alignment line 512 instead of target 422).

In some examples, as shown in FIG. 4B, electronic device 400 present a textual indication 424a for positioning electronic device 400. For example, textual indication 424a includes textual guidance for aligning orientation guidance user interface object 420 with target 422. Further, for example, textual indication 424a instructs the user to move within a threshold distance of the first capture region of the physical environment (e.g., such that a location of electronic device 400 during the first phase of the first capture process is within a predetermined range of locations for capturing images of the physical environment (e.g., within path 308 shown and described with reference to FIG. 3)).

In some examples, as shown in FIG. 4B, user interface 404b includes selectable options. For example, user interface 404b includes selectable option 414 (e.g., described with reference to FIG. 4A) and a selectable option 418. For example, selectable option 418 is selectable to conclude the first capture process (e.g., to generate a virtual representation of the physical environment using one or more images already captured during the first capture process).

Alternatively, for example, selectable option 418 is selectable to conclude the first phase of the first capture process (e.g., in response to selectable option 418, electronic device 400 presents user interface 404a, including a selectable option for initiating a second phase of the first capture process (e.g., as shown and described with reference to FIG. 4F)). Further, in some examples, as shown in FIG. 4B, user interface 404b includes a selectable option 426a. In some examples, in FIG. 4B, selectable option 426a is in an inactive state (e.g., is not selectable in response to touch input). For example, electronic device 400 enables selectable option 426a to be selectable to initiate the second portion of the first phase of the first capture process in accordance with a determination that orientation guidance user interface object 420 is aligned with target 422 (e.g., in accordance with a determination that electronic device 400 is positioned in the first manner). For example, in accordance with a determination that orientation guidance user interface object 420 is not aligned with target 422, as in FIG. 4B, electronic device 400 presents selectable option 426a in the inactive state (e.g., selectable option 426a is not selectable to initiate the second portion of the first phase of the first capture process).

FIG. 4C illustrates electronic device 400 enabling selectable option 426a to be selectable to initiate the second portion of the first phase of the first capture process. For example, as shown in FIG. 4C, electronic device 400 is moved (e.g., position and/or oriented) such that orientation guidance user interface object 420 is aligned with target 422. For example, a user of electronic device 400 positions electronic device 400 (e.g., by re-orienting (e.g., tilting) electronic device 400) such that electronic device 400 is positioned in the first manner.

In some examples, in FIG. 4C, electronic device 400 presents orientation guidance user interface object 420 with a different visual appearance in accordance with a determination that orientation guidance user interface object 420 is aligned with target 422 (e.g., in accordance with a determination that electronic device 400 is moved within an orientation threshold (e.g., 1, 2, 5, 10, 15, 20, 25, or 30 degrees) of the first orientation associated with positioning electronic device 400 in the first manner)). For example, in FIG. 4C, electronic device 400 changes a visual prominence of orientation guidance user interface object 420 (e.g., increases a size and/or brightness of orientation guidance user interface object 420 compared to as shown in FIG. 4B).

For example, in FIG. 4C, electronic device 400 changes a color of orientation guidance user interface object 420 (e.g., electronic device 400 changes a color of orientation guidance user interface object 420 to green in accordance with a determination that electronic device 400 is positioned in the first manner (e.g., and orientation guidance user interface object 420 is aligned with target 422)). In some examples, as shown in FIG. 4C, electronic device 400 changes the level of progress visually indicated by inner portion 434a and outer portion 434b. For example, electronic device 400 presents inner portion 434a with a maximum size (e.g., such that the perimeter of inner portion 434a extends to outer portion 434b) (e.g., to indicate that orientation guidance user interface object 420 is aligned with target 422). For example, electronic device 400 presents the progress bar of outer portion 434b as completely visually modified (e.g., completely shaded in) to indicate that orientation guidance user interface object 420 is aligned with target 422.

In FIG. 4C, electronic device 400 detects a touch input 416b (e.g., a tap input detected on display 430) corresponding to selection of selectable option 426a. In some examples, touch input 416b corresponds to a request to initiate the second portion of the first phase of the first capture process. In some examples, in response to detecting touch input 416b, electronic device 400 initiates the second portion of the first phase of the first capture process in FIG. 4D.

FIG. 4D illustrates electronic device 400 presenting a virtual element 428 for guiding movement of electronic device 400 relative to the physical environment. For example, the second portion of the first phase of the first capture process includes moving electronic device 400 relative to the physical environment (e.g., along a path, such as path 308 described with reference to FIG. 3) while maintaining electronic device 400 positioned in the first manner (e.g., with the pose (e.g., orientation), height, and/or viewing angle electronic device 400 device was moved to during the first portion of the first phase of the first capture process). For example, the second portion of the first phase of the first capture process includes moving electronic device 400 relative to the physical environment while maintaining electronic device 400 within a threshold orientation (e.g., 1, 2, 5, 10, 15, 20, 25, or 30 degrees) from a first orientation associated with positioning electronic device 400 in the first manner. In some examples, electronic device 400 presents virtual element 428 with an animation. For example, the animation demonstrates (e.g., through movement of virtual element 428) how to move electronic device 400 relative to the physical environment during the first phase of the first capture process.

As shown in FIG. 4D, electronic device 400 maintains presentation of target 422. For example, electronic device 400 maintains presentation of target 422 to provide a target point for maintaining alignment of electronic device 400 during the movement of electronic device 400 (e.g., such that the user may maintain the positioning of electronic device 400 in the first manner while moving relative to the physical environment). Further, as shown in FIG. 4D, electronic device 400 optionally presents a textual indication 424b that provides textual guidance for how to move electronic device 400 relative to the physical environment during the first phase of the first capture process.

FIG. 4E illustrates electronic device 400 presenting a different view of environment 402 in response to movement of electronic device 400 during the first phase of the first capture process. For example, from FIG. 4D to FIG. 4E, the user of electronic device 400 moves electronic device 400 relative to the physical environment (e.g., while maintaining positioning of electronic device 400 in the first manner (e.g., by continuing to aim electronic device 400 (e.g., and/or the one or more image sensors of electronic device 400) toward target 422). For example, from FIG. 4D to FIG. 4E, electronic device 400 captures (e.g., automatically (e.g., without user input)) one or more images of the first capture region of the physical environment (e.g., the one or more images captured of the first capture region may be used (e.g., by electronic device 400) to generate a virtual representation of the physical environment at the conclusion of the first capture process).

In some examples, as shown in FIG. 4E, electronic device 400 presents a preview 436 of a virtual representation. Preview 436 is optionally a representation (e.g., a point-cloud representation) of one or more portions of the physical environment that will be included in the virtual representation generated at the conclusion of the first capture process (e.g., based on the images captured during the first capture process). For example, in FIG. 4E, preview 436 includes a point cloud representation of the first capture region of the physical environment (e.g., the region of the physical environment being captured during the first phase of the first capture process). In some examples, as shown in FIG. 4E, the representation is presented on a virtual element 438. In some examples, virtual element 438 includes a plurality of periphery elements that indicate a progress of the first phase of the first capture process (e.g., the periphery elements increase in visual prominence (e.g., increase in size and/or prominence) as the user progresses through the first phase of the first capture process (e.g., all the periphery elements are presented with increased visual prominence when the first phase of the first capture process is complete).

FIG. 4F illustrates electronic device 400 presenting user interface 404a after the completion of the first phase of the first capture process (e.g., the user moved along a path relative to the physical environment while maintaining positioning of electronic device 400 in the first manner). As shown in FIG. 4F, electronic device 400 presents indicator 410a with a different visual appearance (e.g., a different color, shading, and/or brightness) compared to FIG. 4A to visually indicate that the first phase of the first capture process is complete. Further, as shown in FIG. 4F, electronic device 400 presents a representation 412b in user interface 404a. In some examples, representation 412b is a preview of the virtual representation that would be generated (e.g., at the end of the first capture process) using the images captured (e.g., thus far) during the first capture process. In some examples, in FIG. 4F, user interface 404a includes a selectable option 440. For example, selectable option 440 is selectable to review a preview of a virtual representation of the physical environment (e.g., generated using the images captured during the first phase of the first capture process).

As shown in FIG. 4F, user interface 404a includes a selectable option 408b. In some examples, selectable option 408b is selectable to initiate a second phase of the first capture process. In FIG. 4F, electronic device 400 detects a touch input 416c (e.g., a tap input on display 430) corresponding to selection of selectable option 408b. In response to detecting the selection of selectable option 408b, electronic device 400 initiates the second phase of the first capture process in FIG. 4G.

In some examples, FIGS. 4G-4I illustrate a second phase of the first capture process, which optionally has one or more characteristics of the second phase of the capture process described with reference to FIG. 3.

FIGS. 4G-4H illustrate a first portion of the second phase of the first capture process. In some examples, during the first portion of the second phase of the first capture process, electronic device 400 presents one or more virtual elements (e.g., virtual objects) in environment 402 for aligning electronic device 400 (e.g., and/or one or more image sensors of electronic device 400) relative to a second capture region of the physical environment (e.g., a region of the physical environment within the field-of-view of electronic device 400 (e.g., and/or the one or more image sensors of electronic device 400) when electronic device 400 is positioned by the user in the second manner). In some examples, aligning electronic device 400 relative to the second capture region of the physical environment includes positioning electronic device 400 in a second manner (e.g., at a second pose, height, and/or viewing angle (e.g., at an angle of depression relative to the second capture region)). For example, as shown in FIG. 4G, electronic device 400 presents target 422 in a lower region of environment 402 compared to where target 422 was presented during the first phase of the first capture process (e.g., the second capture region of the physical environment is a lower region of the physical environment compared to the first capture region of the physical environment). Further, as shown in FIG. 4G, target 422 is presented on a virtual element 446. For example, electronic device 400 presents virtual element 446 on a floor and/or ground of environment 402 (e.g., to guide a user toward aiming electronic device 400 and/or the one or more image sensors of electronic device 400 toward a lower portion of the physical environment). Further, as shown in FIG. 4G, electronic device 400 presents orientation guidance user interface object 420. In some examples, in FIG. 4G, orientation guidance user interface object 420 visually indicates (e.g., using arrow 432) a target direction (e.g., corresponding to target 422) for positioning electronic device 400 in the second manner for capturing the second capture region of the physical environment.

In some examples, as shown in FIG. 4G, electronic device 400 presents a textual indication 424c for positioning electronic device 400 (e.g., having one or more characteristics of textual indication 424a shown and described with reference to FIG. 4B).

In some examples, as shown in FIG. 4G, electronic device 400 includes a selectable option 426b. In some examples, in FIG. 4G, selectable option 426b is in an inactive state (e.g., is not selectable in response to touch input). For example, electronic device 400 enables selectable option 426b to be selectable to initiate the second portion of the second phase of the first capture process in accordance with a determination that orientation guidance user interface object 420 is aligned with target 422 (e.g., in accordance with a determination that electronic device 400 is positioned in the second manner). For example, in accordance with a determination that orientation guidance user interface object 420 is not aligned with target 422, as in FIG. 4G, electronic device 400 presents selectable option 426b in the inactive state (e.g., selectable option 426b is not selectable to initiate the second portion of the second phase of the first capture process).

FIG. 4H illustrates electronic device 400 enabling selectable option 426b to be selectable to initiate the second portion of the second phase of the first capture process. For example, as shown in FIG. 4H, electronic device 400 is moved (e.g., positioned and/or oriented) such that orientation guidance user interface object 420 is aligned with target 422. For example, a user of electronic device 400 positions electronic device 400 (e.g., by re-orienting (e.g., tilting) electronic device 400) such that electronic device 400 is positioned in the second manner.

Accordingly, as shown in FIG. 4H, electronic device 400 presents orientation guidance user interface object 420 with a different visual appearance compared to the visual appearance of orientation guidance user interface object 420 in FIG. 4G (e.g., the change in visual appearance of orientation guidance user interface object 420 in FIG. 4H has one or more characteristics of the change in visual appearance of orientation guidance user interface object 420 shown and described with reference to FIG. 4C).

In FIG. 4H, electronic device 400 detects a touch input 416d (e.g., a tap input detected on display 430). In some examples, touch input 416d corresponds to a request to initiate the second portion of the second phase of the first capture process. In some examples, in response to detecting touch input 416d, electronic device 400 initiates the second portion of the second phase of the first capture process. In some examples, the second portion of the second phase of the first capture process includes moving electronic device 400 relative to the physical environment (e.g., along a path, such as path 308 described with reference to FIG. 3) while maintaining electronic device 400 positioned in the second manner (e.g., with the pose, height, and/or viewing angle electronic device 400 was moved to during the first portion of the second phase of the first capture process). For example, the second portion of the second phase of the first capture process includes moving electronic device 400 relative to the physical environment while maintaining electronic device 400 within a threshold orientation (e.g., 1, 2, 5, 10, 15, 20, 25, or 30 degrees) from a second orientation associated with positioning electronic device 400 in the second manner.

In some examples, when initiating the second portion of the second phase of the first capture process, electronic device 400 optionally presents a virtual element and/or animation for demonstrating how to move electronic device 400 relative to the physical environment during the second phase of the first capture process (e.g., having one or more characteristics of presenting virtual element 428 shown and described with reference to FIG. 4D).

FIG. 4I illustrates electronic device 400 presenting a different view of environment 402 in response to movement of electronic device 400 during the second phase of the first capture process. For example, from FIG. 4H to FIG. 4I, the user of electronic device 400 moves electronic device 400 relative to the physical environment (e.g., while maintaining positioning of electronic device 400 in the second manner (e.g., by continuing to aim electronic device 400 (e.g., and/or the one or more image sensors of electronic device 400) toward target 422). For example, from FIG. 4H to FIG. 4I, electronic device 400 captures (e.g., automatically (e.g., without user input)) one or more images of the second capture region of the physical environment (e.g., the one or more images captured of the second capture region may be used (e.g., by electronic device 400) to generate a virtual representation of the physical environment at the conclusion of the first capture process).

In some examples, as shown in FIG. 4I, electronic device 400 maintains presentation of target 422 in environment 402 during the second portion of the second phase of the first capture process. For example, electronic device 400 maintains presentation of target 422 to provide a target point for maintaining alignment of electronic device 400 during the movement of electronic device 400 (e.g., such that the user may maintain positioning of electronic device 400 in the second manner while moving relative to the physical environment). Electronic device 400 optionally changes a location of target 422 along virtual element 446 as electronic device 400 is moved relative to the physical environment (e.g., such that target 422 is presented at a location on virtual element 446 that is closest to the current viewpoint of the user and/or electronic device 400 in environment 402).

FIG. 4J illustrates electronic device 400 presenting user interface 404a after the completion of the second phase of the first capture process (e.g., the user moved along a path=while maintaining positioning of electronic device 400 in the second manner). As shown in FIG. 4J, electronic device 400 presents indicator 410b with a different visual appearance (e.g., a different color, shading, and/or brightness) compared to FIG. 4F to visually indicate that the second phase of the first capture process is complete.

As shown in FIG. 4J, user interface 404a includes a selectable option 408c. In some examples, selectable option 408c is selectable to initiate a third phase of the first capture process. In FIG. 4J, electronic device 400 detects a touch input 416e (e.g., a tap input on display 430) corresponding to selection of selectable option 408c. In some examples, in response to detecting the selection of selectable option 408c, electronic device 400 initiates the third phase of the first capture process in FIG. 4K.

In some examples, FIGS. 4K-4M illustrate a third phase of the first capture process, which optionally has one or more characteristics of the third phase of the capture process described with reference to FIG. 3.

FIGS. 4K-4L illustrate a first portion of the third phase of the first capture process. In some examples, during the first portion of the third phase of the first capture process, electronic device 400 presents one or more virtual objects in environment 402 for aligning electronic device 400 (e.g., and/or one or more image sensors of electronic device 400) relative to a third capture region of the physical environment (e.g., a region of the physical environment within the field-of-view of electronic device 400 (e.g., and/or the one or more image sensors of electronic device 400) when electronic device 400 is positioned by the user in the third manner). In some examples, aligning electronic device 400 relative to the third capture region of the physical environment includes positioning electronic device 400 in a third manner (e.g., at a third pose, height, and/or viewing angle (e.g., at an angle of elevation relative to the third capture region)). For example, as shown in FIG. 4K electronic device 400 presents target 422 in a higher region of environment 402 compared to where target 422 was presented during the first phase or the second phase of the first capture process (e.g., the third capture region of the physical environment is a higher region of the physical environment compared to the first capture region or the second capture region). Further, as shown in FIG. 4K, target 422 is presented on a virtual element 448. For example, virtual element 448 visually indicates to a user that positioning electronic device 400 in the third manner includes elevating and/or tilting electronic device 400 to an upward viewing angle. Further, as shown in FIG. 4K, electronic device 400 presents orientation guidance user interface object 420. In some examples, in FIG. 4K, orientation guidance user interface object 420 visually indicates (e.g., using arrow 432) a target direction (e.g., corresponding to target 422) for positioning electronic device 400 in the third manner for capturing the third capture region of the physical environment.

In some examples, as shown in FIG. 4K, electronic device 400 presents a textual indication 424d for positioning electronic device 400 in environment 402 (e.g., having one or more characteristics of textual indication 424a shown and described with reference to FIG. 4B).

FIG. 4L illustrates electronic device 400 enabling selectable option 426c to be selectable to initiate the second portion of the third phase of the first capture process. For example, as shown in FIG. 4L, electronic device 400 is moved (e.g., positioned and/or oriented) such that orientation guidance user interface object 420 is aligned with target 422. For example, a user of electronic device 400 positions electronic device 400 (e.g., by re-orienting (e.g., tilting) electronic device 400) such that electronic device 400 is positioned in the third manner. Accordingly, as shown in FIG. 4L, electronic device 400 presents orientation guidance user interface object 420 with a different visual appearance compared to the visual appearance of orientation guidance user interface object 420 in FIG. 4K (e.g., the change in visual appearance of orientation guidance user interface object 420 in FIG. 4L has one or more characteristics of the change in visual appearance of orientation guidance user interface object 420 shown and described with reference to FIG. 4C).

In FIG. 4L, electronic device 400 detects a touch input 416f (e.g., a tap input detected on display 430). In some examples, touch input 416f corresponds to a request to initiate the second portion of the third phase of the first capture process. In some examples, in response to detecting touch input 416f, electronic device 400 initiates the second portion of the third phase of the first capture process. In some examples, the second portion of the third phase of the first capture process includes moving electronic device 400 relative to the physical environment (e.g., along a path, such as path 308 described with reference to FIG. 3) while maintaining electronic device 400 positioned in the third manner (e.g., with the pose, height, and/or viewing angle electronic device 400 was moved to during the first portion of the third phase of the first capture process). For example, the second portion of the third phase of the first capture process includes moving electronic device 400 relative to the physical environment while maintaining electronic device 400 within a threshold orientation (e.g., 1, 2, 5, 10, 15, 20, 25, or 30 degrees) from a third orientation associated with positioning electronic device 400 in the third manner.

In some examples, when initiating the second portion of the third phase of the first capture process, electronic device 400 optionally presents a virtual element and/or animation for demonstrating how to move electronic device 400 relative to the physical environment during the third phase of the first capture process (e.g., having one or more characteristics of presenting virtual element 428 shown and described with reference to FIG. 4D).

FIG. 4M illustrates electronic device 400 presenting a different view of environment 402 in response to movement of electronic device 400 during the third phase of the first capture process. For example, from FIG. 4L to FIG. 4M, the user of electronic device 400 moves electronic device 400 relative to the physical environment (e.g., while maintaining positioning of electronic device 400 in the third manner (e.g., by continuing to aim electronic device 400 (e.g., and/or the one or more image sensors of electronic device 400) toward target 422). For example, from FIG. 4L to FIG. 4M, electronic device 400 captures (e.g., automatically (e.g., without user input)) one or more images of the third capture region of the physical environment (e.g., the one or more images captured of the third capture region (e.g., and/or of the first capture region and/or second capture region) may be used (e.g., by electronic device 400) to generate a virtual representation of the physical environment at the conclusion of the first capture process).

In some examples, as shown in FIG. 4M, electronic device 400 maintains presentation of target 422 in environment 402 on virtual element 448 (e.g., to provide a target point for maintaining alignment of electronic device 400 during the movement of electronic device 400 relative to the physical environment (e.g., such that the user may maintain positioning of electronic device 400 in the third manner while moving relative to the physical environment)).

FIG. 4M illustrates an alternative example of electronic device 400 presenting virtual element 438. In some examples, electronic device 400 does not present a preview of a virtual representation (e.g., preview 436 shown and described with reference to FIG. 4E) during the phases of the first capture process. For example, as shown in FIG. 4M, electronic device 400 presents virtual element 438 without a preview of a virtual representation. For example, electronic device 400 updates the presentation of virtual element 438 to indicate progress of the third phase of the first capture process (e.g., by changing a visual appearance of the plurality of periphery elements, as described with reference to FIG. 4E).

FIG. 4N illustrates electronic device 400 presenting user interface 404a after the completion of the third phase of the first capture process (e.g., the user moved along a path relative to the physical environment while maintaining positioning of electronic device 400 in the third manner). As shown in FIG. 4N, electronic device 400 presents indicator 410c with a different visual appearance (e.g., a different color, shading, and/or brightness) compared to FIG. 4J to visually indicate that the third phase of the first capture process is complete.

In some examples, in FIG. 4N, the user has completed the first capture process (e.g., the first capture process includes three phases, and the user has completed the three phases of the first capture process (e.g., as shown and described with reference to FIGS. 4A-4M)). In some examples, as shown in FIG. 4N, user interface 404a includes an icon 442 and a selectable option 444. In some examples, selectable option 444 is selectable to save the images captured during the first capture process (e.g., in a memory of electronic device 400 and/or in a file of a respective application associated with user interface 404a and/or the first capture process). Additionally, or alternatively, in some examples, selectable option 444 is selectable to generate a virtual representation of the physical environment using the images captured during the first capture process (e.g., the virtual representation is generated using the respective application associated with user interface 404a and/or the first capture process). In some examples, icon 442 is selectable (e.g., through touch input) to export a file including information (e.g., data) associated with the first capture process (e.g., the file includes the images captured during the first capture process). For example, the file is exported to a second electronic device in communication with electronic device 400 (e.g., and the virtual representation is generated using the second electronic device).

It should be understood that the first capture process shown and described with reference to FIGS. 4A-4N is an example capture process and more, fewer, or different phases can be performed in the same or in a different order than described.

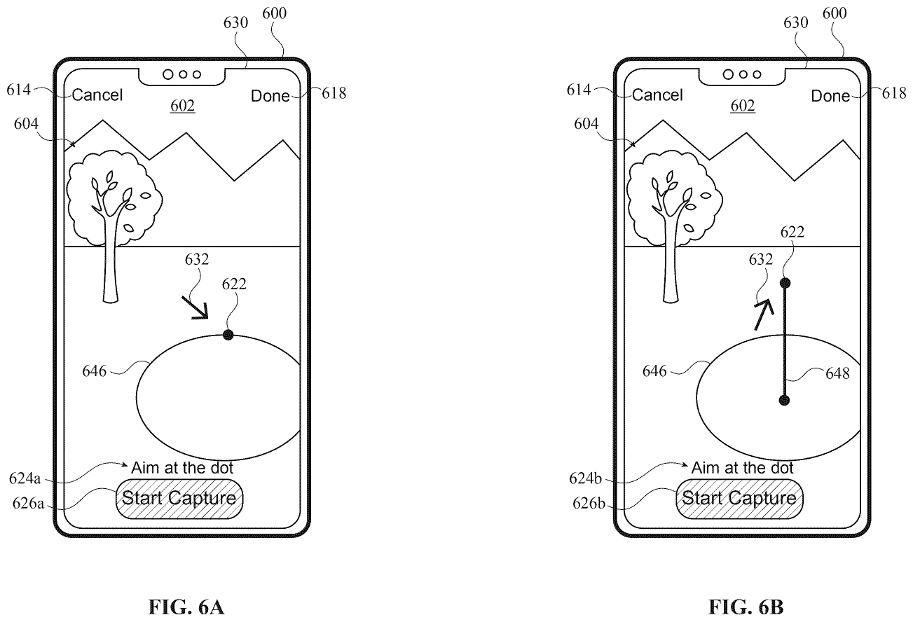

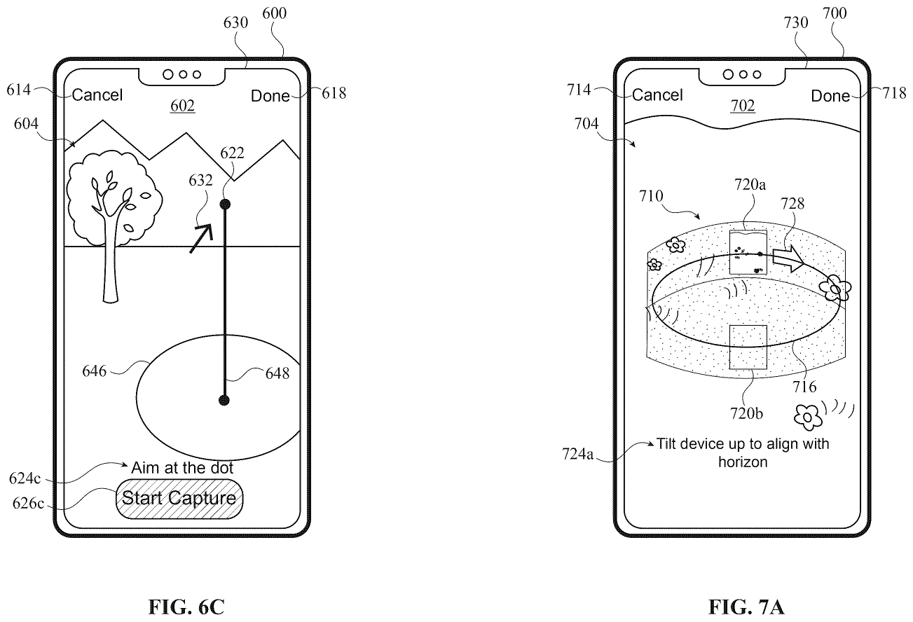

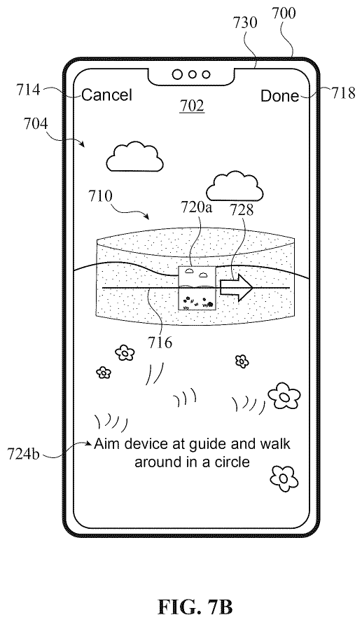

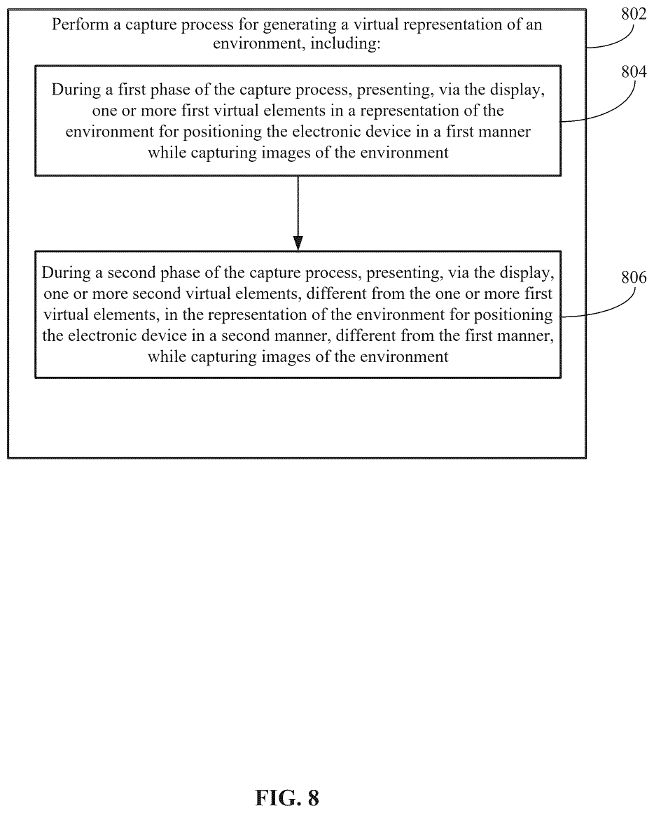

The first capture process shown and described with reference to FIGS. 4A-4N is an example capture process that can be performed using an electronic device, such as electronic device 100 and/or 200 described above. The electronic device is optionally configured to perform different types of capture processes, such as the first capture process, a second capture process (e.g., as shown and described with reference to FIGS. 5A-5N), a third capture process (e.g., as shown and described with reference to FIGS. 6A-6C), and/or a fourth capture process (e.g., as shown and described with reference to FIGS. 7A-7B). For example, the different types of capture processes are associated with a respective application that is accessible using the electronic device, and a user of the electronic device may select their preferred capture process through the respective application. Alternatively, each type of capture process is associated with a different application (e.g., the different applications are all accessible using the electronic device). In some examples, each type of capture process may include the presentation of different virtual elements and/or include a different number of phases.

FIGS. 5A-5N illustrate examples of an electronic device presenting example user interfaces for a second capture process for generating a virtual representation of an environment, according to some examples of the disclosure. The second capture process optionally has one or more characteristics of the capture process shown and described with reference to FIG. 3 and/or the first capture process shown and described with reference to FIGS. 4A-4N.

In some examples, the second capture process may include presenting an initial and/or intermediate user interface, such as user interface 404a described above, when initiating the second capture process and/or in between phases of the second capture process. Such a user interface is omitted in FIGS. 5A-5N for brevity.

FIG. 5A illustrates a user interface 504 for a second capture process for generating a virtual representation of an environment (e.g., a physical environment). User interface 504 is optionally presented (e.g., displayed) on a display 530 of an electronic device 500, which optionally has one or more characteristics of electronic device 100 and/or 200 shown and described with reference to FIGS. 1-2. In some examples, display 530 has one or more characteristics of display(s) 224 shown and described with reference to FIG. 2. In some examples, display 530 is a touch-sensitive display.

As shown in FIG. 5A, user interface 504 includes a view of environment 502. In some examples, environment 502 has one or more characteristics of environment 402 shown and described with reference to FIGS. 4A-4N. Further, FIG. 5A (e.g., and FIGS. 5B-5N) includes a top-down view 550 of a physical environment 570. Top-down view 550 includes a representation of a user 552 of electronic device 500 (e.g., user 552 is holding electronic device 500). A current position of user 552 and/or electronic device 500 relative to physical environment 570 during the second capture process is illustrated in top-down view 550 in FIGS. 5A-5N. In some examples, a representation of physical environment 570 presented, via display 530 (e.g., the representation of physical environment 570 is included in environment 502). In some examples, the second capture process includes capturing images of one or more portions of physical environment 570 (e.g., such that a virtual representation of the one or more portions of physical environment 570 may be generated).

In some examples, FIGS. 5A-5B illustrate an initial phase of the second capture process. For example, during the initial phase of the second capture process (e.g., before the first, second, third, and fourth phases of the second capture process described below), electronic device 500 presents one or more virtual elements (e.g., virtual objects) in environment 502 for defining a region of physical environment 570 that images are captured from during the second capture process. For example, the region of environment 502 corresponds to a set of locations in physical environment 570 that user 552 and/or electronic device 500 will capture images from during the different phases of the second capture process (e.g., the region of physical environment 570 defines a path for moving electronic device 500 during each phase of the second capture process).

As shown in FIG. 5A, electronic device 500 presents a reticle 562 in environment 502. For example, user 552 may use reticle 562 to align electronic device 500 toward a region of physical environment 570 that user 552 desires to capture images from during the second capture process (e.g., the user aligns electronic device 500 by changing an orientation of electronic device 500 relative to physical environment 570). Further, in FIG. 5A, user interface 504 includes a textual indication 524a. For example, textual indication 524a instructs user 552 to use reticle 562 to target the region of physical environment 570 user 552 desires to capture images from during the second capture process.

As shown in FIG. 5A, user interface 504 includes selectable options. For example, user interface 504 includes selectable option 514, which optionally has one or more characteristics of selectable option 414 described above with reference to FIG. 4A. For example, user interface 504 includes selectable option 518, which optionally has one or more characteristics of selectable option 418 described above with reference to FIG. 4B. For example, user interface 504 includes selectable option 508a which is selectable to continue the initial phase of the second capture process. In FIG. 5A, electronic device 500 detects a touch input 516a (e.g., a tap input) corresponding to selection of selectable option 508a. In some examples, in response to detecting the selection of selectable option 508a, electronic device 500 presents a virtual element 510 in environment 502 in FIG. 5B. For example, virtual element 510 is presented at a location in environment 502 corresponding to the location of reticle 562 had when electronic device 500 detected touch input 516a (e.g., the location of reticle 562 in FIG. 5A corresponds to a center of virtual element 510 in FIG. 5B).

In some examples, user 552 may use virtual element 510 to define a size of the region of physical environment 570 user 552 desires to capture images from during the second capture process. As shown in FIG. 5B, electronic device 500 presents virtual element 510 with an adjustment affordance 560. For example, adjustment affordance 560 is selectable (e.g., by a touch and/or drag input on display 530) to change a size of virtual element 510 in environment 502 (e.g., a drag gesture performed over adjustment affordance 560 changes a size of virtual element 510 in accordance with the drag gesture (e.g., a drag gesture with movement toward a center of virtual element 510 decreases a size of virtual element 510, and a drag gesture with movement away from the center of virtual element 510 increases a size of virtual element 510)).

Top-down view 550 in FIG. 5B includes a schematic representation of a path 554. For example, path 554 has one or more characteristics of path 308 shown and described with reference to FIG. 3. Path 554 optionally corresponds to a perimeter of virtual element 510 (e.g., virtual element 510 defines a set of locations that electronic device 500 guides user 552 to move to (e.g., while maintaining a positioning of electronic device 500) during each phase of the second capture process). In some examples, during each phase of the second capture process, electronic device 500 may capture images of physical environment 570 (e.g., portion 558 of physical environment 570 shown within path 554) when electronic device 500 is located within a threshold distance (e.g., 0.1, 0.2, 0.5, 1, 2, 5, or 10 meters) from path 554 (e.g., in accordance with a determination that electronic device 500 is moved outside of the threshold distance from path 554 during the second capture process, electronic device 500 forgoes capturing images (e.g., and presents a textual indication instructing user 552 to move electronic device 500 closer to capture portion 558 of physical environment 570)). For example, in FIG. 5, top-down view 550 illustrates a reference perimeter 556 that schematically represents the threshold distance from path 554 (e.g., the portion of physical environment 570 located between reference perimeter 556 and path 554 corresponds to the defined region of physical environment 570 that electronic device 500 may capture images of physical environment 570 from during the second capture process (e.g., corresponding to the region of physical environment 570 defined during the initial phase of the second capture process)).

In FIG. 5B, user interface 504 includes a textual indication 524b. For example, textual indication 524b instructs user 552 to adjust the size of virtual element 510 to fit the region of physical environment 570 user 552 desires to capture images from during the second capture process (e.g., the size of virtual element 510 relative to environment 502 corresponds to the defined region of physical environment 570 user 552 may capture images from during the second capture process).

As shown in FIG. 5B, user interface 504 includes a selectable option 508b. In some examples, selectable option 508b is selectable to continue the second capture process (e.g., by finalizing the region of physical environment 570 that images may be captured from during the second capture process). In FIG. 5B, electronic device 500 detects a touch input 516b (e.g., a tap input) corresponding to selection of selectable option 508b. For example, in response to detecting selection of selectable option 508b, electronic device 500 initiates a first phase of the second capture process (e.g., as shown in FIG. 5C). Alternatively, for example, in response to detecting selection of selectable option 508b, electronic device 500 presents an intermediate user interface (e.g., having one or more characteristics of user interface 404a shown and described with reference to FIGS. 4A, 4F, 4J, and 4N).

FIGS. 5C-5F illustrate a first phase of the second capture process, which optionally has one or more characteristics of the first phase of the capture process described with reference to FIG. 3 and/or the first phase of the first capture process described with reference to FIGS. 4B-4E. In some examples, the first phase of the second capture process includes aligning electronic device 500 (e.g., and/or one or more image sensors of electronic device 500) toward a horizon of physical environment 570 (e.g., electronic device 500 presents one or more virtual objects (e.g., orientation guidance user interface object 520 and/or alignment line 512) during the first portion of the first phase of the second capture process for aligning electronic device 500 and/or the one or more image sensors of electronic device 500 toward the horizon of physical environment 570).

FIG. 5C illustrates a first portion of the first phase of the second capture process. In some examples, the first portion of the first phase of the second capture process has one or more characteristics of the first portion of the first phase of the first capture process described above. As shown in FIG. 5C, electronic device 500 presents an orientation guidance user interface object 520 and an alignment line 512 for positioning electronic device 500 in the first manner (e.g., for aligning electronic device 500 relative to a first capture region of physical environment 570). For example, moving electronic device 500 (e.g., changing the orientation of electronic device 500) causes orientation guidance user interface object 520 to move within user interface 504 (e.g., tilting electronic device 500 upward causes downward movement of orientation guidance user interface object 520, and tilting electronic device 500 downward causes downward movement of orientation guidance user interface object 520). For example, electronic device 500 is aligned in the first manner (e.g., has a first height, pose (e.g., orientation), and/or viewing angle relative to physical environment 570) when orientation guidance user interface object 520 is aligned with alignment line 512.

In some examples, as shown in FIG. 5C, electronic device 500 presents a textual indication 524c for positioning electronic device 500. For example, textual indication 524c includes textual guidance for aligning orientation guidance user interface object 520 with alignment line 512. Additionally, or alternatively, in some examples, electronic device 500 presents a textual indication that instructs user 552 to move electronic device 500 within a threshold distance of the first capture region of physical environment 570 (e.g., within a threshold distance of path 554).

In FIG. 5C, user interface 504 includes a selectable option 526a. In some examples, in FIG. 5C, selectable option 526a is in an inactive state (e.g., is not selectable in response to touch input). In some examples, electronic device 500 enables selectable option 526a to be selectable to initiate the second portion of the first phase of the second capture process in accordance with a determination that orientation guidance user interface object 520 is aligned with alignment line 512 (e.g., in accordance with a determination that electronic device 500 is positioned in the first manner and/or within a threshold orientation of a first orientation associated with positioning electronic device 500 in the first manner).

FIG. 5D illustrates electronic device 500 enabling selectable option 526a to be selectable to initiate the second portion of the first phase of the second capture process. For example, as shown in FIG. 5D, electronic device 500 is moved (e.g., positioned and/or oriented in the first manner) such that orientation guidance user interface object 520 is aligned with alignment line 512 (e.g., user 552 tilts electronic device 500 upward such that orientation guidance user interface object 520 moves downward in user interface 504 to alignment line 512). Electronic device 500 optionally presents orientation guidance user interface object 520 and/or alignment line 512 with a different visual appearance (e.g., compared to FIG. 5C) in accordance with a determination that orientation guidance user interface object 520 is aligned with alignment line 512 (e.g., electronic device 500 changes a color, brightness, and/or visual prominence (e.g., size) of one or more portions of orientation guidance user interface object 520 and/or alignment line 512 in accordance with a determination that electronic device 500 is positioned in the first manner (e.g., and/or in accordance with a determination that electronic device 500 is moved within an orientation threshold (e.g., 1, 2, 5, 10, 15, 20, 25, or 30 degrees) of a first orientation associated with positioning electronic device 500 in the first manner)).

In FIG. 5D, electronic device 500 detects a touch input 516c (e.g., a tap input detected on display 530) corresponding to selection of selectable option 526a. In some examples, touch input 516c corresponds to a request to initiate the second portion of the first phase of the second capture process. In some examples, in response to detecting touch input 516c, electronic device 500 initiates the second portion of the first phase of the second capture process in FIG. 5E. In some examples, the second portion of the first phase of the second capture process has one or more characteristics of the second portion of the first phase of the first capture process described above.

FIG. 5E illustrates electronic device 500 presenting a virtual element 528a for guiding movement of electronic device 500 relative to physical environment 570. In some examples, presenting virtual element 528a includes one or more characteristics of presenting virtual element 428 as shown and described with reference to FIG. 4D. Further, as shown in FIG. 5E, electronic device 500 presents a textual indication 524e that provides textual guidance for how to move electronic device 500 relative to physical environment 570 during the first phase of the second capture process.

FIG. 5F illustrates electronic device 500 presenting a different view of environment 502 in response to movement of electronic device 500 during the first phase of the second capture process. For example, as shown in top-down view 550, user 552 moves electronic device 500 relative to physical environment 570 (e.g., along path 554 and/or within a threshold distance of path 554) from FIG. 5E to FIG. 5F (e.g., while maintaining positioning of electronic device 500 in the first manner). For example, from FIG. 5E to FIG. 5F, electronic device 500 captures (e.g., automatically (e.g., without user input)) one or more images of the first capture region of physical environment 570. In some examples, as shown in FIG. 5F, electronic device 500 presents a target 522 in environment 502 during the second portion of the first phase of the second capture process. For example, electronic device 500 presents target 522 to assist user 552 in maintaining positioning of electronic device 500 in the first manner while user 552 is moving electronic device 500 relative to physical environment 570 (e.g., user 552 maintains positioning of electronic device 500 in the first manner by aiming electronic device 500 (e.g., and/or the one or more image sensors of electronic device 500) toward target 522 while moving electronic device 500 during the first phase of the second capture process).

Although not shown in FIG. 5F, it should be appreciated that electronic device 500 may present a preview (e.g., having one or more characteristics of preview 436 described above) and/or one or more virtual elements for presenting progress of the first phase of the capture process (e.g., such as the periphery elements described above with reference to virtual element 438). The preview and/or the one or more virtual elements for presenting progress are optionally presented during each phase of the second capture process.

FIGS. 5G-5H illustrate a second phase of the second capture process, which optionally has one or more characteristics of the second phase of the capture process shown and described with reference to FIG. 3 and/or the second phase of the first capture process shown and described with reference to FIGS. 4G-4I. Particularly, FIGS. 5G-5H illustrate a first portion of the second phase of the second capture process (the second portion of the second phase of the second capture process is omitted for brevity (e.g., the second portion of the second phase of the second capture process has one or more characteristics of the second portion of the first phase of the second capture process)). In some examples, the second phase of the second capture process includes aligning electronic device 500 (e.g., and/or the one or more image sensors of electronic device 500) away (e.g., below) a horizon of physical environment 570 (e.g., electronic device 500 presents one or more virtual objects (e.g., orientation guidance user interface object 520 and/or alignment line 512) during the first portion of the second phase of the second capture process for aligning electronic device 500 and/or the one or more image sensors of electronic device 500 below the horizon of physical environment 570).

As shown in FIG. 5G, electronic device 500 presents orientation guidance user interface object 520 and alignment line 512 for positioning electronic device 500 in the second manner (e.g., for aligning electronic device 500 relative to a second capture region of physical environment 570, which is optionally lower than the first capture region of physical environment 570). Further, as shown in FIG. 5G, electronic device 500 presents a textual indication 524f for positioning electronic device 500 in the second manner (e.g., for aligning orientation guidance user interface object 520 with alignment line 512).

In FIG. 5G, user interface 504 includes a selectable option 526b. For example, selectable option 526b is in an inactive state (e.g., is not selectable in response to touch input). In some examples, electronic device 500 enables selectable option 526b to be selectable to initiate the second portion of the second phase of the second capture process in accordance with a determination that orientation guidance user interface object 520 is aligned with alignment line 512 (e.g., in accordance with a determination that electronic device 500 is positioned in the second manner and/or within a threshold orientation of a second orientation associated with positioning electronic device 500 in the second manner).

FIG. 5H illustrates electronic device 500 enabling selectable option 526b to be selectable to initiate the second portion of the second phase of the second capture process. For example, as shown in FIG. 5H, electronic device 500 is moved (e.g., positioned and/or oriented in the second manner) such that orientation guidance user interface object 520 is aligned with alignment line 512 (e.g., user 552 tilts electronic device 500 downward such that orientation guidance user interface object 520 moves upward in user interface 504 to alignment line 512). In FIG. 5H, electronic device 500 optionally presents orientation guidance user interface object 520 and/or alignment line 512 with a different visual appearance compared to FIG. 5G (e.g., as described above with reference to FIG. 5D). In some examples, in response to detecting a touch input corresponding to selection of selectable option 526b, electronic device 500 initiates the second portion of the second phase of the second capture process, which optionally has one or more characteristics of the second portion of the first phase of the second capture process (the second portion of the second phase of the second capture process is not shown for brevity). For example, the second portion of the second phase of the second capture process includes moving electronic device 500 relative to physical environment 570 (e.g., along path 554 and/or within a threshold distance of path 554) while maintaining positioning of electronic device 500 in the second manner (e.g., and/or within a threshold orientation of a second orientation associated with positioning electronic device 500 in the second manner).

FIGS. 5I-5J illustrates a third phase of the second capture process, which optionally has one or more characteristics of the third phase of the capture process shown and described with reference to FIG. 3 and/or the third phase of the first capture process shown and described with reference to FIGS. 4K-4M. Particularly, FIGS. 5I-5J illustrate a first portion of the third phase of the second capture process (the second portion of the third phase of the second capture process is omitted for brevity (e.g., the second portion of the third phase of the second capture process has one or more characteristics of the second portion of the first phase of the second capture process)). In some examples, the third phase of the second capture process includes aligning electronic device 500 (e.g., and/or the one or more image sensors of electronic device 500 away (e.g., above) a horizon of physical environment 570 (e.g., electronic device 500 presents one or more virtual objects (e.g., orientation guidance user interface object 520 and/or alignment line 512) during the first portion of the third phase of the second capture process for aligning electronic device 500 and/or the one or more image sensors of electronic device 500 above the horizon of physical environment 570).

As shown in FIG. 5I, electronic device 500 presents orientation guidance user interface object 520 and alignment line 512 for positioning electronic device 500 in the third manner (e.g., for aligning electronic device 500 relative to a third capture region of physical environment 570, which is optionally above the first capture region and/or the second capture region of physical environment 570). Further, as shown in FIG. 5I, electronic device 500 presents a textual indication 524g for positioning electronic device 500 in the third manner (e.g., for aligning orientation guidance user interface object 520 with alignment line 512).

In FIG. 5I, user interface 504 includes a selectable option 526c. For example, selectable option 526c is in an inactive state (e.g., is not selectable in response to touch input). In some examples, electronic device 500 enables selectable option 526c to be selectable to initiate the second portion of the third phase of the second capture process in accordance with a determination that orientation guidance user interface object 520 is aligned with alignment line 512 (e.g., in accordance with a determination that electronic device 500 is positioned in the third manner and/or within a threshold orientation of a third orientation associated with positioning electronic device 500 in the third manner).

FIG. 5J illustrates electronic device 500 enabling selectable option 526c to be selectable to initiate the second portion of the third phase of the second capture process. For example, as shown in FIG. 5J, electronic device 500 is moved (e.g., positioned and/or oriented in the third manner) such that orientation guidance user interface object 520 is aligned with alignment line 512 (e.g., user 552 tilts electronic device 500 upward such that orientation guidance user interface object 520 moves downward to alignment line 512). In FIG. 5J, electronic device 500 optionally presents orientation guidance user interface object 520 and/or alignment line 512 with a different visual appearance compared to FIG. 5I (e.g., as described with reference to FIG. 5D). In some examples, in response to detecting a touch input corresponding to selection of selectable option 526c, electronic device 500 initiates the second portion of the third phase of the second capture process, which optionally has one or more characteristics of the second portion of the first phase of the second capture process (the second portion of the third phase of the second capture process is not shown for brevity). For example, the second portion of the third phase of the second capture process includes moving electronic device 500 relative to physical environment 570 (e.g., along path 554 and/or within a threshold distance of path 554) while maintaining positioning of electronic device 500 in the third manner (e.g., and/or within a threshold orientation of a third orientation associated with positioning electronic device 500 in the third manner).

FIGS. 5K-5N illustrate a fourth phase of the second capture process. In some examples, during the fourth phase of the second capture process, user 552 directs electronic device 500 (e.g., and/or one or more input devices of electronic device 500) outward from path 554 (e.g., away from portion 558 of physical environment 570 shown within path 554 in top-down view 550). The fourth phase of the second capture process is optionally one of multiple phases of the second capture process that include directing electronic device 500 and/or one or more input devices of electronic device 500 away from portion 558 of physical environment 570 (e.g., the multiple phases include capturing images away from portion 558 of physical environment 570 while electronic device 500 is positioned in different manners). In some examples, the fourth phase of the second capture process includes positioning electronic device 500 in the first manner, second manner, and/or the third manner (e.g., above, below, and/or toward a horizon of physical environment 570). For example, as shown in FIGS. 5K-5N, the fourth phase of the second capture process includes aligning electronic device 500 (e.g., and/or one or more input devices of electronic device 500) below a horizon of physical environment 570.

In some examples, FIGS. 5K-5L illustrate a first portion of the fourth phase of the second capture process. As shown in FIG. 5K, electronic device 500 presents orientation guidance user interface object 520 and alignment line 512 for positioning electronic device 500 (e.g., such that electronic device 500 is aligned below a horizon of physical environment 570). Further, as shown in FIG. 5K, electronic device 500 presents a textual indication 524h for positioning electronic device 500 (e.g., for aligning orientation guidance user interface object 520 with alignment line 512).

In FIG. 5K, user interface 504 includes a selectable option 526d. For example, selectable option 526d is in an inactive state (e.g., is not selectable in response to touch input). In some examples, electronic device 500 enables selectable option 526d to be selectable to initiate a second portion of the fourth phase of the second capture process in accordance with a determination that orientation guidance user interface object 520 is aligned with alignment line 512.

FIG. 5L illustrates electronic device 500 enabling selectable option 526d to be selectable to initiate the second portion of the fourth phase of the second capture process. For example, as shown in FIG. 5H, electronic device 500 is moved (e.g., positioned and/or oriented) such that orientation guidance user interface object 520 is aligned with alignment line 512 (e.g., user 552 tilts electronic device 500 downward such that orientation guidance user interface object 520 moves upward in user interface 504 to alignment line 512). In FIG. 5L, electronic device 500 optionally presents orientation guidance user interface object 520 and/or alignment line 512 with a different visual appearance compared to in FIG. 5K (e.g., as described above with reference to FIG. 5D).

In FIG. 5L, electronic device 500 detects a touch input 516d (e.g., a tap input detected on display 530) corresponding to selection of selectable option 526d. In some examples, touch input 516d corresponds to a request to initiate the second portion of the fourth phase of the second capture process. In some examples, in response to detecting touch input 516d, electronic device 500 initiates the second portion of the fourth phase of the second capture process in FIG. 5M.

FIG. 5M illustrates electronic device 500 presenting a virtual element 528b for guiding movement of electronic device 500 relative to physical environment 570. In some examples, presenting virtual element 528b includes one or more characteristics of presenting virtual element 428 shown and described with reference to FIG. 4D. Further, as shown in FIG. 5M, electronic device 500 presents a textual indication 524i that provides textual guidance for how to move electronic device 500 relative to physical environment 570 (e.g., aiming outward from path 554 (e.g., away from portion 558)) during the fourth phase of the second capture process.

FIG. 5N illustrates electronic device 500 presenting a different view of environment 502 in response to movement of electronic device 500 during the fourth phase of the second capture process. For example, as shown in top-down view 550, user 552 moves electronic device 500 relative to physical environment 570 (e.g., along path 554 and/or within a threshold distance of path 554 while oriented outward from path 554 (e.g., aimed away from portion 558 of physical environment 570)). For example, from FIG. 5M to FIG. 5N, electronic device 500 captures (e.g., automatically (e.g., without user input)) one or more images of physical environment 570 while electronic device 500 is aligned away from portion 558 of physical environment 570.

In some examples, after completing the second capture process, electronic device 500 may save the images captured during the second capture process (e.g., in a memory of electronic device 500 and/or in a file of a respective application associated with user interface 504 and/or the second capture process) and/or generate a virtual representation of the physical environment using the images (e.g., and/or export a file including the images captured during the second capture process to a second electronic device in communication with electronic device 500 (e.g., a virtual representation is generated using the second electronic device)).

It should be understood that the second capture process shown and described with reference to FIGS. 5A-5N is an example capture process and more, fewer, or different phases can be performed in the same or in a different order than described.

FIGS. 6A-6C illustrate examples of an electronic device presenting example user interfaces for a third capture process for generating a virtual representation of an environment, according to some examples of the disclosure. The third capture process optionally has one or more characteristics of the capture process shown and described with reference to FIG. 3, the first capture process shown and described with reference to FIGS. 4A-4N, and/or the second capture process shown and described with reference to FIGS. 5A-5N.

FIGS. 6A-6C illustrates a user interface 604 for a third capture process for generating a virtual representation of an environment (e.g., a physical environment). User interface 604 is optionally presented (e.g., displayed) on a display 630 of an electronic device 600, which optionally has one or more characteristics of electronic device 100 and/or 200 shown and described with reference to FIGS. 1-2. In some examples, display 630 has one or more characteristics of display(s) 224 shown and described with reference to FIG. 2. In some examples, display 630 is a touch-sensitive display.

In some examples, the third capture process includes multiple phases that include positioning electronic device 600 in different manners. In some examples, as described above with reference to the first capture process and/or the second capture process, each phase of the third capture process may include a first portion for positioning electronic device 600 and a second portion for moving electronic device 600 relative to the physical environment (e.g., while maintaining the height, pose, and/or viewing angle of electronic device 600 (e.g., maintaining electronic device 600 within a threshold orientation)). FIGS. 6A-6C illustrate three phases of the third capture process, although the third capture process may include more or fewer phases. For brevity, FIGS. 6A-6C do not illustrate the second portions of the three phases of the third capture process (e.g., the second portion of each phase of the third capture process has one or more characteristics of the second portion of the first, second, and/or third phases of the first and/or second capture processes described above).

In some examples, the third capture process may include presenting an initial and/or intermediate user interface, such as user interface 404a shown and described with reference to FIG. 4A, when initiating the second capture process and/or in between phases of the second capture process. Such a user interface is omitted in FIGS. 6A-6C for brevity.

As shown in FIGS. 6A-6C, user interface 604 includes a view of an environment 602. In some examples, environment 602 has one or more characteristics of environment 402 shown and described with reference to FIGS. 4A-4N and/or environment 502 shown and described with reference to FIGS. 5A-5N.

In some examples, electronic device 600 presents one or more virtual elements (e.g., virtual objects) in environment 602 during each phase of the third capture process for positioning electronic device 600 in particular manner (e.g., in a first, second, and/or third manner as described above). In some examples, electronic device 600 presents a respective type of virtual element (e.g., target 622 and/or second virtual element 648) at a different height during each phase of the third capture process to guide a user of electronic device 600 in positioning electronic device 600 in a particular manner.

In some examples, electronic device 600 presents textual indications (e.g., textual indication 624a shown in FIG. 6A, textual indication 624b shown in FIG. 6B, and/or textual indication 624c shown in FIG. 6C) in environment 602 during each phase of the third capture process, which optionally have one or more characteristics of textual indication 424a shown and described with reference to FIG. 4B.

FIG. 6A illustrates a first phase of the third capture process. As shown in FIG. 6A, electronic device 600 presents a target 622 on a first virtual element 646. In some examples, electronic device 600 presents target 622 in a lower region of environment 602 (e.g., and first virtual element 646 on a floor and/or ground of environment 602) to guide a user of electronic device 600 in positioning electronic device 600 in a first manner (e.g., positioning electronic device 600 in the first manner includes orienting electronic device 600 and/or one or more image sensors of electronic device 600 below a horizon of the physical environment (e.g., such that a viewing angle of electronic device 600 to a first capture region of the physical environment is an angle of depression)). Further, as shown in FIG. 6A, electronic device 600 presents an orientation guidance user interface object 620. For example, orientation guidance user interface object 620 indicates a target direction (e.g., corresponding to target 622) for positioning electronic device 600 in the first manner (e.g., for capturing a first capture region of the physical environment). For example, electronic device 600 updates the target direction indicated by orientation guidance user interface object 620 while electronic device 600 is moved (e.g., tilted) by a user relative to the physical environment (e.g., such that the target direction continues to correspond to target 622). A length of orientation guidance user interface object 620 optionally corresponds to a progress of electronic device 600 toward being aligned with target 622 (e.g., a length of orientation guidance user interface object 620 decreases as electronic device 600 becomes closer to being positioned in the first manner).

In some examples, user interface 604 includes selectable options. For example, selectable options 614 and 618 have one or more characteristics of selectable option 414 and/or 418 described above. In some examples, in FIG. 6A, selectable option 626a is in an inactive state (e.g., is not selectable in response to touch input). For example, electronic device 600 enables selectable option 626a to be selectable to initiate a second portion of the first phase of the third capture process in accordance with a determination that electronic device 600 is positioned in the first manner (e.g., electronic device 600 and/or the one or more image sensors of electronic device 600 are aimed toward target 622 (e.g., electronic device 600 presents target 622 at and/or near (e.g., within 0.001, 0.005, 0.01, 0.05, or 0.1 meter) of a center of display 630). In some examples, the second portion of the first phase of the third capture process has one or more characteristics of the second portion of the first, second, and/or third phase of the first capture process and/or the second capture process described above.

FIG. 6B illustrates a second phase of the third capture process. In some examples, during the second phase of the third capture process, electronic device 600 presents target 622 at a different height in environment 602 compared to during the first phase of the third capture process shown in FIG. 6A. In some examples, as shown in FIG. 6B, electronic device 600 presents target 622 on a second virtual element 648 (optionally extending from first virtual element 646). For example, second virtual element 648 visually indicates to a user that positioning electronic device 600 in the second manner includes elevating and/or tilting electronic device 600 upward compared to positioning electronic device 600 in the first manner (e.g., positioning electronic device 600 in the first manner includes positioning electronic device 600 below a horizon of the physical environment (e.g., toward a first capture region of the physical environment), and positioning electronic device 600 in the second manner includes positioning electronic device 600 toward a horizon of the physical environment (e.g., toward a second capture region of the physical environment)). Further, as shown in FIG. 6B, electronic device 600 presents orientation guidance user interface object 620. For example, orientation guidance user interface object 620 indicates a target direction (e.g., corresponding to target 622) for positioning electronic device 600 in the second manner.

In some examples, in FIG. 6B, selectable option 626b is in an inactive state (e.g., is not selectable in response to touch input). For example, electronic device 600 enables selectable option 626b to be selectable to initiate a second portion of the second phase of the third capture process in accordance with a determination that electronic device 600 is positioned in the second manner (e.g., electronic device 600 and/or the one or more image sensors of electronic device 600 are aimed toward target 622). In some examples, the second portion of the second phase of the third capture process has one or more characteristics of the second portion of the first, second, and/or third phase of the first capture process and/or the second capture process described above.

FIG. 6C illustrates a third phase of the third capture process. In some examples, during the third phase of the third capture process, electronic device 600 presents target 622 at a different height in environment 602 compared to during the first phase of the third capture process shown in FIG. 6A and/or the second phase of the third capture process shown in FIG. 6B. In some examples, as shown in FIG. 6C, electronic device 600 presents target 622 on second virtual element 648 (optionally extending from first virtual element 646). For example, second virtual element 648 is presented with a greater height during the third phase of the third capture process compared to during the second phase of the third capture process (e.g., because the third phase of the third capture process includes capturing images of a third capture region of the physical environment that is at a greater elevation compared to the regions of the physical environment captured during the first phase (e.g., a first capture region) or the second phase (e.g., a second capture region). For example, second virtual element 648 visually indicates to a user that positioning electronic device 600 in the third manner includes elevating and/or tilting electronic device 600 upward compared to positioning electronic device 600 in the first manner and/or second manner (e.g., positioning electronic device 600 in the third manner includes positioning electronic device 600 above a horizon of the physical environment (e.g., such that a viewing angle of electronic device 600 relative to the third capture region of the physical environment is an angle of elevation)). Further, as shown in FIG. 6C, electronic device 600 presents orientation guidance user interface object 620. For example, orientation guidance user interface object 620 indicates a target direction (e.g., corresponding to target 622) for positioning electronic device 600 in the third manner.

In some examples, in FIG. 6C, selectable option 626c is in an inactive state (e.g., is not selectable in response to touch input). For example, electronic device 600 enables selectable option 626c to be selectable to initiate a second portion of the third phase of the third capture process in accordance with a determination that electronic device 600 is positioned in the third manner (e.g., electronic device 600 and/or the one or more image sensors of electronic device 600 are aimed toward target 622). In some examples, the second portion of the third phase of the third capture process has one or more characteristics of the second portion of the first, second, and/or third phase of the first capture process and/or the second capture process described above.

In some examples, after completing the third capture process, electronic device 600 may save the images captured of the physical environment during the third capture process (e.g., in a memory of electronic device 600 and/or in a file of a respective application associated with user interface 604 and/or the third capture process) and/or generate a virtual representation of the physical environment using the images (e.g., and/or export a file including the images captured during the third capture process to a second electronic device in communication with electronic device 600 (e.g., a virtual representation is generated using the second electronic device)).

It should be understood that the third capture process shown and described with reference to FIGS. 6A-6C is an example capture process and more, fewer, or different phases can be performed in the same or in a different order than described.

FIGS. 7A-7B illustrate examples of an electronic device presenting an example user interface for a fourth capture process for generating a virtual representation of an environment, according to some examples of the disclosure.

FIG. 7A illustrates a user interface 704 for a fourth capture process for generating a virtual representation of an environment (e.g., a physical environment). User interface 704 is optionally presented (e.g., displayed) on a display 730 of an electronic device 700, which optionally has one or more characteristics of electronic device 100 and/or electronic device 200 shown and described with reference to FIGS. 1-2. In some examples, display 730 has one or more characteristics of display(s) 224 shown and described with reference to FIG. 2. In some examples, display 730 is a touch-sensitive display.

As shown in FIG. 7A, user interface 704 includes a view of an environment 702. In some examples, environment 702 has one or more characteristics of environment 402 shown and described with reference to FIGS. 4A-4N, environment 502 shown and described with reference to FIGS. 5A-5N, and/or environment 602 shown and described with reference to FIGS. 6A-6C.

In some examples, FIG. 7A illustrates a first phase of the fourth capture process. For example, during the first phase of the fourth capture process, electronic device 700 presents one or more virtual elements (e.g., virtual objects) in environment 702 for positioning electronic device 700 in a particular manner (e.g., in a first, second, and/or third manner as described above). For example, positioning electronic device 700 in the particular manner includes aligning a first virtual object (e.g., orientation guidance user interface object 720a) with a second virtual object (e.g., orientation guidance user interface object 720b).

As shown in FIG. 7A, electronic device 700 presents a virtual object 710 in environment 702. In some examples, virtual object 710 is a three-dimensional virtual object (e.g., with a cylindrical shape) that includes a plurality of virtual elements for positioning electronic device 700 relative to the physical environment. Virtual object 710 is optionally presented as at least partially transparent (e.g., 1, 2, 5, 10, 15, 20, 25, 50, 75, or 90 percent transparent) such that at least a portion of environment 702 is visible through virtual object 710. For example, electronic device 700 presents virtual object 710 with a tinting effect (e.g., with a color and/or shading). In some examples, virtual object 710 includes a plurality of virtual elements for positioning electronic device 700 in a respective manner relative to the physical environment (e.g., toward a horizon of the physical environment). For example, as shown in FIG. 7A, virtual object 710 includes a virtual element 716 presented along a perimeter of virtual object 710. For example, as shown in FIG. 7A, electronic device 700 presents orientation guidance user interface objects 720a and 720b along virtual element 716 (e.g., on opposite sides of virtual object 710). In some examples, electronic device 700 modifies a view of virtual object 710 in environment 702 as a height, pose, and/or viewing angle of electronic device 700 changes relative to the physical environment. For example, as electronic device 700 is positioned closer to a respective pose (e.g., a respective pose associated with positioning electronic device 700 in a first manner), orientation guidance user interface object 720b (e.g., and a portion of virtual element 716 that orientation guidance user interface object 720b is presented on) is moved closer to orientation guidance user interface object 720a (e.g., such that virtual object 710 and/or virtual element 716 appear to be aligning with itself, as shown in FIG. 7B). Further, in some examples, electronic device 700 modifies an appearance of orientation guidance user interface object 720a as the positioning of electronic device 700 is changes. For example, as shown in FIG. 7A, orientation guidance user interface object 720a includes a representation of a current view of the physical environment (e.g., representing a current view of the physical environment from one or more image sensors of electronic device 700), and the representation of the current view of the physical environment is updated as the viewpoint of electronic device 700 changes (e.g., to represent a view of the physical environment from an updated position of the one or more image sensors of electronic device 700).

As shown in FIG. 7A, electronic device 700 presents a textual indication 724a, which optionally has one or more characteristics of textual indication 424a shown and described with reference to FIG. 4B. In some examples, textual indication 724a guides a user in aligning orientation guidance user interface object 720b with orientation guidance user interface object 720a (e.g., such that electronic device 700 is positioned in a respective manner (e.g., aligned toward a horizon of the physical environment)).

In some examples, as shown in FIG. 7A, user interface 704 includes selectable options 714 and 718, which optionally have one or more characteristics of selectable options 414 and 418 described above.

FIG. 7B illustrates as second phase of the fourth capture process according to some examples of the disclosure. For example, during the second phase of the fourth capture process, electronic device 700 presents one or more virtual elements (e.g., virtual objects) in environment 702 for guiding movement of electronic device 700 (e.g., while electronic device 700 maintains a positioning (e.g., and/or within a threshold orientation) from the first phase of the fourth capture process).

As shown in FIG. 7B, user interface 704 includes a different view of environment 702 than shown in FIG. 7A. For example, from FIG. 7A to FIG. 7B, a user of electronic device 700 changes a position of electronic device 700 (e.g., tilted electronic device 700) such that orientation guidance user interface object 720b aligns with orientation guidance user interface object 720a (and/or such that virtual element 716 aligns with itself). In some examples, in FIG. 7B, in accordance with a determination that electronic device 700 is positioned in a particular manner (e.g., a first manner (e.g., and/or in accordance with a determination orientation guidance user interface object 720b is at least partially aligned with orientation guidance user interface object 720a)), electronic device 700 ceases to present textual indication 724a and presents textual indication 724b. For example, textual indication 724b instructs a user of electronic device 700 to move electronic device 700 relative to the physical environment (e.g., along a path, such as path 308 shown and described with reference to FIG. 3). Moving electronic device 700 relative to the physical environment optionally includes moving electronic device 700 around virtual object 710 (e.g., around a periphery of virtual object 710) while optionally targeting (e.g., aiming toward) orientation guidance user interface object 720a (e.g., in order to maintain a positioning of electronic device 700 during the movement (e.g., electronic device 700 updates a location of orientation guidance user interface object 720a during the movement of electronic device 700 such that orientation guidance user interface object 720a is presented at a location on virtual element 716 that is closest to the current viewpoint of the user and/or electronic device 700 in environment 702)). Further, as shown in FIG. 7B, electronic device 700 presents direction indicator 728. Direction indicator 728 optionally guides a user of electronic device 700 to move electronic device 700 in a particular direction relative to the physical environment.

In some examples, electronic device 700 updates a visual appearance of virtual object 710 (e.g., and/or the plurality of virtual elements presented with virtual object 710) during the movement of electronic device 700 during the second phase of the fourth capture process (e.g., to guide the user of electronic device 700 in maintaining the height, pose (e.g., orientation), and/or viewing angle of electronic device 700 during the second phase of the fourth capture process). For example, in accordance with a determination that a user of electronic device 700 modifies an alignment of electronic device 700 (e.g., a height, pose (e.g., orientation), and/or viewing angle of electronic device 700) during the movement, electronic device 700 updates the alignment of orientation guidance user interface object 720b relative to orientation guidance user interface object 720a (e.g., if electronic device 700 is tilted upward, electronic device 700 moves orientation guidance user interface object 720b downward from the position orientation guidance user interface object 720a, and if electronic device 700 is tilted downward, electronic device 700 moves orientation guidance user interface object 720b upward from the position of orientation guidance user interface object 720a). For example, in accordance with a determination that a user of electronic device 700 modifies an alignment of electronic device 700 during the movement, electronic device 700 ceases to align virtual element 716 with itself (e.g., by an amount and/or direction that is based on the amount and/or direction of the change of alignment of electronic device 700). For example, in accordance with a determination that a user of electronic device 700 modifies an alignment of electronic device 700 during the movement, electronic device 700 moves direction indicator 728 from virtual element 716 (e.g., by an amount and/or direction that is based on the amount and/or direction of the change of alignment of electronic device 700). Based on the updates in visual appearance to virtual object 710, a user of electronic device 700 may counteract unintended changes in position (e.g., by moving electronic device 700 to a position that causes alignment of orientation guidance user interface object 720b with orientation guidance user interface object 720a).

During the second phase of the fourth capture process, electronic device 700 optionally updates orientation guidance user interface object 720a to include a preview of a set of images captured of the physical environment. For example, electronic device 700 expands a size of orientation guidance user interface object 720a when images of new portions of the physical environment are captured during the second phase of the fourth capture process. Further, during the second phase of the fourth capture process, electronic device 700 optionally indicates a progress of the second phase of the fourth capture process. For example, electronic device 700 moves a location of direction indicator 728 along virtual element 716 to indicate a progression of movement of electronic device 700 along a path (e.g., the path surrounds the perimeter of virtual object 710) (e.g., the second phase of the fourth capture process is complete once target indicator 728 has progressed along the entire perimeter of virtual object 710).

In some examples, after completing the fourth capture process, electronic device 700 may save the images captured during the fourth capture process (e.g., in a memory of electronic device 700 and/or in a file of a respective application associated with user interface 704 and/or the fourth capture process) and/or generate a virtual representation of the physical environment using the images (e.g., and/or export a file including the images captured during the fourth capture process to a second electronic device in communication with electronic device 700 (e.g., a virtual representation is generated using the second electronic device)).

It should be understood that the fourth capture process shown and described with reference to FIGS. 7A-7B is an example capture process and more, fewer, or different phases can be performed in the same or in a different order than described. For example, the fourth capture process includes additional phases for capturing images of the physical environment while electronic device 700 is positioned in manners different than those shown in FIGS. 7A-7B (e.g., such that electronic device 700 (e.g., and/or the one or more image sensors of electronic device 700) are aligned away from (e.g., above and/or below) a horizon of the physical environment).

FIG. 8 illustrates a flow diagram of an example process for performing a capture process for generating a virtual representation of an environment according to some examples of the disclosure. In some examples, process 800 begins at an electronic device in communication with (e.g., including or communicating signals with) a display and one or more input devices (e.g., image sensor(s) 210, location sensor(s) 214, orientation sensor(s) 216, microphone(s) 218, and/or touch-sensitive surface(s) 220 shown and described with reference to FIG. 2). In some examples, the electronic device has one or more characteristics of electronic devices 100 and/or 200 described above. In some examples, the electronic device is a mobile device, such as a mobile phone, tablet, and/or laptop computer. In some examples, the electronic device is a head-mounted device (e.g., including one or more displays for presenting an XR environment).

In some examples, at 802, the electronic device performs a capture process for generating a virtual representation of an environment, such as the capture process shown and described with reference to FIG. 3, the first capture process shown and described with reference to FIGS. 4A-4N, the second capture process shown and described with reference to FIGS. 5A-5N, the third capture process shown and described with reference to FIGS. 6A-6C, and/or the fourth capture process shown and described with reference to FIGS. 7A-7B. In some examples, the environment is a physical (e.g., real-world) environment (e.g., including one or more physical objects). For example, the virtual representation is a three-dimensional model of one or more regions of the physical environment (e.g., the three-dimensional model is of a scene and/or landscape, and/or of one or more physical objects).

In some examples, the three-dimensional environment is an XR environment having one or more characteristics of environment 402, 502, 602, and/or 702 described above. In some examples, the three-dimensional environment corresponds to (e.g., include a representation of) a real-world (e.g., physical) environment. For example, the virtual representation is a three-dimensional model of one or more regions of the real-world environment (e.g., the three-dimensional model is of a scene and/or landscape, and/or of one or more physical objects in the scene and/or landscape). In some examples, the electronic device may present, via the display, a current view of the three-dimensional environment and may present one or more virtual elements overlaid on and/or within the three-dimensional environment (e.g., as virtual and/or augmented reality objects).

In some examples, at 804, performing the capture process for generating the virtual representation of the environment includes, during a first phase of the capture process, presenting, via the display, one or more first virtual elements in a representation of the environment for positioning the electronic device in a first manner while capturing images of the environment. For example, as shown in FIGS. 4G-4H, a second phase of the first capture process includes presenting a target 422 on a virtual element 446 (e.g., in a lower region of environment 402) while electronic device 400 captures images of the physical environment. In some examples, the representation of the environment is included within a three-dimensional environment presented via the display. For example, the three-dimensional environment is an XR environment having one or more characteristics of environment 402, 502, 602, and/or 702 described above. In some examples, the electronic device presents the one or more first virtual elements overlaid on and/or within the representation of the environment.

In some examples, at 806, performing the capture process for generating the virtual representation of the environment includes, during a second phase of the capture process, presenting, via the display, one or more second virtual elements, different from the one or more first virtual elements, in the representation of the environment for positioning the electronic device in a second manner, different from the first manner, while capturing images of the environment. For example, as shown in FIGS. 4K-4L, a third phase of the first capture process includes presenting target 422 on a virtual element 448 (e.g., in an upper region of environment 402) while electronic device 400 captures images of the physical environment. In some examples, the electronic device presents the one or more second virtual elements overlaid on and/or within the representation of the environment.

It is understood that process 800 is an example and that more, fewer, or different operations can be performed in the same or in a different order. Additionally, the operations in process 800 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method comprising, at an electronic device in communication with a display and one or more input devices, performing a capture process for generating a virtual representation of an environment, including, during a first phase of the capture process, presenting, via the display, one or more first virtual elements in a representation of the environment for positioning the electronic device in a first manner while capturing images of the environment, and during a second phase of the capture process, presenting, via the display, one or more second virtual elements, different from the one or more first virtual elements, in the representation of the environment for positioning the electronic device in a second manner, different from the first manner, while capturing images of the environment.

Additionally, or alternatively, in some examples, performing the capture process further includes, during a third phase of the capture process, presenting, via the display, one or more third virtual elements, different from the one or more first virtual elements and the one or more second virtual elements, in the representation of the environment for positioning the electronic device in a third manner, different from the first manner and the second manner, while capturing images of the environment.

Additionally, or alternatively, in some examples, capturing images of the environment during the first phase of the capture process includes maintaining the positioning of the electronic device in the first manner during movement of the electronic device relative to the environment, and capturing images of the environment during the second phase of the capture process includes maintaining the positioning of the electronic device in the second manner during movement of the electronic device relative to the environment.

Additionally, or alternatively, in some examples, positioning the electronic device in the first manner includes aligning the electronic device toward a horizon of the environment, and positioning the electronic device in the second manner includes aligning the electronic device away from the horizon of the environment.

Additionally, or alternatively, in some examples, aligning the electronic device away from the horizon of the environment includes aligning the electronic device below the horizon of the environment. In some examples, the capture process further includes, during a third phase of the capture process, presenting, via the display, one or more third virtual elements, different from the one or more first virtual elements and the one or more second virtual elements, in the representation of the environment for aligning the electronic device above the horizon of the environment while capturing images of the environment.

Additionally, or alternatively, in some examples, presenting the one or more first virtual elements includes, during a first portion of the first phase of the capture process, presenting, via the display, one or more first virtual objects for aligning the electronic device relative to a first capture region of the environment, and during a second portion, after the first portion, of the first phase of the capture process, presenting, via the display, one or more second virtual objects for guiding movement of the electronic device in the environment while maintaining the alignment of the electronic device relative to the first capture region of the environment.

Additionally, or alternatively, in some examples, presenting the one or more second virtual elements includes, during a first portion of the second phase of the capture process, presenting, via the display, one or more third virtual objects for aligning the electronic device relative to a second capture region, different from the first capture region, of the environment, and during a second portion, after the first portion, of the second phase of the capture process, presenting, via the display, one or more fourth virtual objects for guiding movement of the electronic device in the environment while maintaining alignment of the electronic device relative to the second capture region of the environment.

Additionally, or alternatively, in some examples, the one or more first virtual objects includes an orientation guidance user interface object. In some examples, presenting the orientation guidance user interface object during the first portion of the first phase of the capture process includes, in accordance with a determination that the electronic device is not aligned relative to the first capture region of the environment, presenting the orientation guidance user interface object with a first visual appearance, and in accordance with a determination that the electronic device is aligned relative to the first capture region of the environment, presenting the orientation guidance user interface object with a second visual appearance, different from the first visual appearance.

Additionally, or alternatively, in some examples, the method further comprises, during the first portion of the first phase of the capture process, presenting, via the display, a selectable option. In some examples, presenting the selectable option includes, in accordance with a determination that the electronic device is aligned relative to the first capture region of the environment, enabling the selectable option to be selectable to initiate the second portion of the first phase of the capture process. In some examples, presenting the selectable option includes, in accordance with a determination that the electronic device is not aligned relative to the first capture region of the environment, forgoing enabling the selectable option to be selectable to initiate the second portion of the first phase of the capture process.

Additionally, or alternatively, in some examples, the first phase of the capture process includes guiding movement of the electronic device within a first set of locations of the environment while capturing images of a first capture region of the environment, and the second phase of the capture process includes guiding movement of the electronic device within the first set of locations of the environment while capturing images of a second capture region, different from the first capture region, of the environment.

Additionally, or alternatively, in some examples, the first set of locations correspond to a path that at least partially surrounds the first capture region of the environment, the first phase of the capture process includes guiding movement of the electronic device along the path while directing a first input device of the electronic device toward the first capture region of the environment, and the second phase of the capture process includes guiding movement of the electronic device along the path while directing the first input device of the electronic device away from the first capture region of the environment.

Additionally, or alternatively, in some examples, performing the capture process further includes, during a third phase, prior to the first phase and the second phase, presenting, via the display, one or more third virtual elements in the representation of the environment for defining a region of the environment for capturing images of the environment from, wherein the first phase of the capture process and the second phase of the capture process include capturing images from the region of the environment.

Additionally, or alternatively, in some examples, the one or more first virtual elements includes a first respective type of virtual object presented with a first height in the representation of the environment, and the one or more second virtual elements includes the first respective type of virtual object presented with a second height, different from the first height, in the representation of the environment.

Additionally, or alternatively, in some examples, the capture process includes the first phase and the second phase in accordance with a determination that the capture process is a first type of capture process. In some examples, the method further comprises, in accordance with a determination that the capture process is a second type of capture process, performing the capture process for generating the virtual representation of the environment includes: during a third phase of the capture process, presenting, via the display, a set of third virtual elements in the representation of the environment for positioning the electronic device in a third manner, wherein positioning the electronic device in the third manner includes modifying a location of a first virtual object until the first virtual object is aligned with a second virtual object; and during a fourth phase of the capture process, presenting, via the display, a set of fourth virtual elements in the representation of the environment for guiding movement of the electronic device relative to the environment while maintaining positioning of the electronic device in the third manner.

Some examples of the disclosure are directed to an electronic device, comprising: one or more processors, memory, and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with a display and one or more input devices:
performing a capture process for generating a virtual representation of an environment, including:
during a first phase of the capture process, presenting, via the display, one or more first virtual elements in a representation of the environment for positioning the electronic device in a first manner while capturing images of the environment; and
during a second phase of the capture process, presenting, via the display, one or more second virtual elements, different from the one or more first virtual elements, in the representation of the environment for positioning the electronic device in a second manner, different from the first manner, while capturing images of the environment.

2. The method of claim 1, wherein performing the capture process further includes:
during a third phase of the capture process, presenting, via the display, one or more third virtual elements, different from the one or more first virtual elements and the one or more second virtual elements, in the representation of the environment for positioning the electronic device in a third manner, different from the first manner and the second manner, while capturing images of the environment.

3. The method of claim 1, wherein:
capturing images of the environment during the first phase of the capture process includes maintaining the positioning of the electronic device in the first manner during movement of the electronic device relative to the environment, and
capturing images of the environment during the second phase of the capture process includes maintaining the positioning of the electronic device in the second manner during movement of the electronic device relative to the environment.

4. The method of claim 1, wherein:
positioning the electronic device in the first manner includes aligning the electronic device toward a horizon of the environment, and
positioning the electronic device in the second manner includes aligning the electronic device away from the horizon of the environment.

5. The method of claim 4, wherein aligning the electronic device away from the horizon of the environment includes aligning the electronic device below the horizon of the environment, the capture process further including:
during a third phase of the capture process, presenting, via the display, one or more third virtual elements, different from the one or more first virtual elements and the one or more second virtual elements, in the representation of the environment for aligning the electronic device above the horizon of the environment while capturing images of the environment.

6. The method of claim 1, wherein presenting the one or more first virtual elements includes:
during a first portion of the first phase of the capture process, presenting, via the display, one or more first virtual objects for aligning the electronic device relative to a first capture region of the environment, and
during a second portion, after the first portion, of the first phase of the capture process, presenting, via the display, one or more second virtual objects for guiding movement of the electronic device in the environment while maintaining the alignment of the electronic device relative to the first capture region of the environment.

7. The method of claim 6, wherein the one or more first virtual objects includes an orientation guidance user interface object, wherein presenting the orientation guidance user interface object during the first portion of the first phase of the capture process includes:
in accordance with a determination that the electronic device is not aligned relative to the first capture region of the environment, presenting the orientation guidance user interface object with a first visual appearance, and
in accordance with a determination that the electronic device is aligned relative to the first capture region of the environment, presenting the orientation guidance user interface object with a second visual appearance, different from the first visual appearance.

8. An electronic device comprising:
one or more processors;
memory; and
one or more programs, wherein the one or more programs are stored in the memory and configured to be executed by the one or more processors, the one or more programs including instructions for performing a capture process for generating a virtual representation of an environment, including:
during a first phase of the capture process, presenting, via a display, one or more first virtual elements in a representation of the environment for positioning the electronic device in a first manner while capturing images of the environment; and
during a second phase of the capture process, presenting, via the display, one or more second virtual elements, different from the one or more first virtual elements, in the representation of the environment for positioning the electronic device in a second manner, different from the first manner, while capturing images of the environment.

9. The electronic device of claim 8, wherein performing the capture process further includes:
during a third phase of the capture process, presenting, via the display, one or more third virtual elements, different from the one or more first virtual elements and the one or more second virtual elements, in the representation of the environment for positioning the electronic device in a third manner, different from the first manner and the second manner, while capturing images of the environment.

10. The electronic device of claim 8, wherein:
capturing images of the environment during the first phase of the capture process includes maintaining the positioning of the electronic device in the first manner during movement of the electronic device relative to the environment, and
capturing images of the environment during the second phase of the capture process includes maintaining the positioning of the electronic device in the second manner during movement of the electronic device relative to the environment.

11. The electronic device of claim 8, wherein the capture process includes:
positioning the electronic device in the first manner includes aligning the electronic device toward a horizon of the environment, and
positioning the electronic device in the second manner includes aligning the electronic device away from the horizon of the environment.

12. The electronic device of claim 11, wherein aligning the electronic device away from the horizon of the environment includes aligning the electronic device below the horizon of the environment, the capture process further including:
during a third phase of the capture process, presenting, via the display, one or more third virtual elements, different from the one or more first virtual elements and the one or more second virtual elements, in the representation of the environment for aligning the electronic device above the horizon of the environment while capturing images of the environment.

13. The electronic device of claim 8, wherein presenting the one or more first virtual elements includes:
during a first portion of the first phase of the capture process, presenting, via the display, one or more first virtual objects for aligning the electronic device relative to a first capture region of the environment, and
during a second portion, after the first portion, of the first phase of the capture process, presenting, via the display, one or more second virtual objects for guiding movement of the electronic device in the environment while maintaining the alignment of the electronic device relative to the first capture region of the environment.

14. The electronic device of claim 13, wherein the one or more first virtual objects includes an orientation guidance user interface object, wherein presenting the orientation guidance user interface object during the first portion of the first phase of the capture process includes:
in accordance with a determination that the electronic device is not aligned relative to the first capture region of the environment, presenting the orientation guidance user interface object with a first visual appearance, and
in accordance with a determination that the electronic device is aligned relative to the first capture region of the environment, presenting the orientation guidance user interface object with a second visual appearance, different from the first visual appearance.

15. A non-transitory computer readable storage medium storing one or more programs, the one or more programs comprising instructions, which when executed by one or more processors of an electronic device, cause the electronic device to perform a capture process for generating a virtual representation of an environment, including:
during a first phase of the capture process, presenting, via a display, one or more first virtual elements in a representation of the environment for positioning the electronic device in a first manner while capturing images of the environment; and
during a second phase of the capture process, presenting, via the display, one or more second virtual elements, different from the one or more first virtual elements, in the representation of the environment for positioning the electronic device in a second manner, different from the first manner, while capturing images of the environment.

16. The non-transitory computer readable storage medium of claim 15, the capture process further includes:
during a third phase of the capture process, presenting, via the display, one or more third virtual elements, different from the one or more first virtual elements and the one or more second virtual elements, in the representation of the environment for positioning the electronic device in a third manner, different from the first manner and the second manner, while capturing images of the environment.

17. The non-transitory computer readable storage medium of claim 15, wherein:
capturing images of the environment during the first phase of the capture process includes maintaining the positioning of the electronic device in the first manner during movement of the electronic device relative to the environment, and
capturing images of the environment during the second phase of the capture process includes maintaining the positioning of the electronic device in the second manner during movement of the electronic device relative to the environment.

18. The non-transitory computer readable storage medium of claim 15, wherein:
positioning the electronic device in the first manner includes aligning the electronic device toward a horizon of the environment, and
positioning the electronic device in the second manner includes aligning the electronic device away from the horizon of the environment.

19. The non-transitory computer readable storage medium of claim 18, wherein aligning the electronic device away from the horizon of the environment includes aligning the electronic device below the horizon of the environment, the capture process further including:
during a third phase of the capture process, presenting, via the display, one or more third virtual elements, different from the one or more first virtual elements and the one or more second virtual elements, in the representation of the environment for aligning the electronic device above the horizon of the environment while capturing images of the environment.

20. The non-transitory computer readable storage medium of claim 15, wherein presenting the one or more first virtual elements includes:
during a first portion of the first phase of the capture process, presenting, via the display, one or more first virtual objects for aligning the electronic device relative to a first capture region of the environment, and
during a second portion, after the first portion, of the first phase of the capture process, presenting, via the display, one or more second virtual objects for guiding movement of the electronic device in the environment while maintaining the alignment of the electronic device relative to the first capture region of the environment.
